(19) United States
(12) Patent Application Publication
(10) Pub. No.: US 2017/0109843 A1
(43) Pub. Date: Apr. 20, 2017

(54) SYSTEM AND METHOD FOR MOBILE-ASSISTED DIGITAL WAITER

(71) Applicant: Back Home Foods LLC, Dallas, TX (US)

(72) Inventors: Jeffrey Ryan Berg, Dallas, TX (US); Ronald Peter Taliancich, JR., Frisco, TX (US); Meade Monger, Dallas, TX (US)

(21) Appl. No.: 14/973,536

(22) Filed: Dec. 17, 2015

Related U.S. Application Data
(60) Provisional application No. 62/244,184, filed on Oct. 20, 2015.

(51) Int. Cl. G06Q 50/12; G06Q 10/02; G06Q 20/32

(52) U.S. Cl. CPC G06Q 50/12; G06Q 20/3224; G06Q 10/02

(57) ABSTRACT

Aspects of the disclosure provide a mobile-assisted digital waiter service implemented via a communication network. In some aspects of the disclosure, a mobile device may be configured with a mobile-assisted digital water application, which when executed by the mobile device, may assist a user/customer with the process of dining at a restaurant or ordering items for take-out from a restaurant. For example, the digital waiter application may enable a user/customer to view menus, place orders and pay their bill from their mobile device. In an aspect, the digital waiter application may enhance the dining experience for the user/customer by providing a customized digital menu to the user/customer, which includes at least one customized menu item generated based on a prior order history of the customer.

### CLAIM OF PRIORITY UNDER 35 U.S.C. §119

The present application for patent claims priority to Provisional Application No. 62/244,184 entitled “System and Method for Mobile-Assisted Digital Waiter” filed Oct. 20, 2015, and assigned to the assignee hereof and hereby expressly incorporated by reference herein.

### TECHNICAL FIELD

Aspects of the present disclosure relate generally to wireless communication networks, and more particularly, to mobile devices and systems for implementing a digital waiter service.

### BACKGROUND

Restaurants and other food service providers rely on repeat customers and positive reviews to maintain and grow their business. To ensure customers are provided an enjoyable dining experience, many restaurants are looking for ways to improve efficiencies by minimizing delays and reducing costs. Delays may be introduced at any point in the dining experience. For example, when dining out at a busy restaurant, customers may need to add their name to a wait list. If the customer considers the wait time to be too extensive, the customer may choose to leave the restaurant, resulting in a loss of business to the restaurant. Once seated, customers typically must wait for a server or other wait staff person to arrive at their table to take their order, which may cause undesired delays to the customer. In addition, customers may also need to locate their server during their meal to request additional items, and at the end of their meal to provide payment, which may introduce further delays to the customer. These delays may negatively affect the customer's dining experience.

Even if the dining experience is pleasant, the additional cost incurred when adding a tip to their bill may deter a customer from more frequent patronage. In addition, if the customer requires payment to be made by credit or debit card, the customer may be hesitant to return to the restaurant if the customer is concerned about fraud resulting from the removal of the customer's credit/debit card from the table for processing.

Moreover, if the customer is a repeat customer, the restaurant may desire to create an even more pleasurable dining experience with knowledge of the customer's prior order history. However, restaurants are currently not equipped to maintain each customer's prior order history or to inform their wait staff personnel of the customer's order history.

Finally, costs associated with reprinting menus often prevent culinary changes from being implemented at the speed desired by discerning customers, and even more so by chefs themselves. Real-time pricing may only be accomplished with market price items or the removal of all prices from menus; both of which provide the customer with a strong deterrent for selecting these items.

### SUMMARY OF THE INVENTION

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a mobile device in communication with a communication network. The mobile device includes a processor, a display, a user input device, and a wireless transceiver configured to receive data corresponding to a digital menu associated with a restaurant via the communication network. The processor may be configured to render the data corresponding to the digital menu on the display. In one example, the digital menu includes a plurality of menu items including at least one customized menu item corresponding to a prior order placed with the restaurant by a user of the mobile device. The processor may further be configured to determine a selected menu item of the plurality of menu items selected by the user of the mobile device via the user input device, and to transmit the selected menu item to a network device associated with the restaurant via the wireless transceiver and the communication network to place a current order with the restaurant.

Another aspect of the disclosure provides a method for implementing a mobile-assisted digital waiter. The method includes receiving, via a network interface coupled to a communication network, a request for a digital menu of a restaurant from a customer operating a mobile device in wireless communication with the communication network. The method further includes determining, by a processor, a customer identifier of the customer, retrieving, from a memory, a prior order history of the customer based on the customer identifier, and generating, by the processor, the digital menu based on the prior order history. In one example, the digital menu includes a plurality of menu items, in which at least one of the menu items is a customized menu item selected from the prior order history. The method further includes transmitting, via the network interface, the digital menu to the mobile device, and receiving, via the network interface, a current order including a selected menu item selected from the plurality of menu items by the customer.

Examples of additional aspects of the disclosure follow. In some aspects, the digital menu is customized based on at least one of a date, a day of the week, a time of day, or a menu class selected by the user of the mobile device. In some aspects, the selected menu item includes at least one menu item modification entered by the user. In some aspects, the processor is further configured to determine the at least one customized menu item based on the prior order stored in the mobile device, and include the customized menu item in the digital menu.

In some aspects, the processor is further configured to render additional data corresponding to menu class options on the display, determine the menu class selected from the menu class options by the user of the mobile device via the user input device and transmit the menu class to the network device via the wireless transceiver and the communication network. In one example, the digital menu corresponds to the menu class selected by the user of the mobile device. In some aspects, the processor is further configured to determine a respective temporal visibility range for each of the plurality of menu items on the digital menu, compare the temporal visibility range for each of the plurality of menu items with current temporal information to determine a subset of menu items having the current temporal information in the respective temporal visibility range, and render the subset of menu items on the display.

In some aspects, the processor is further configured to render the current order including the selected menu item on the display, receive a submit order command from the user of the mobile device via the user input device, and transmit the current order including the selected menu item to the network device in response to receiving the submit order command. In some aspects, the processor is further configured to initiate a timer on the mobile device in response to determining the selected menu item, and activate an alert on the mobile device upon expiration of the timer when the submit order command has not been received.

In some aspects, the mobile device further includes an orientation system configured to monitor motion of the mobile device, and the processor is further configured to receive orientation information from the orientation system, determine that the mobile device is stationary based on the orientation information, initiate a timer on the mobile device in response to determining that the mobile device is stationary, and automatically transmit the current order including the selected menu item to the network device upon expiration of the timer.

In some aspects, the processor is further configured to determine a table number corresponding to a location of the mobile device, and transmit the table number with the selected menu item to the network device. In some aspects, the mobile device further includes a positioning system configured to calculate a current location of the mobile device, and the processor is further configured to transmit an arrival notification to the network device when the current location of the mobile device is within a predetermined distance from the restaurant.

In some aspects, the processor is further configured to receive a seating notification from the network device indicating that the restaurant has a table ready to seat the user, and render the seating notification on the display. In some aspects, the processor is further configured to receive a valet message from the network device that includes a valet ticket number to valet a vehicle associated with the customer, and render the valet message on the display. In some aspects, the processor is further configured to determine payment for the current order has been completed, provide a prompt on the display for the user to request their vehicle using the valet ticket number, and transmit a valet request including the valet ticket number to the network device to request the vehicle.

In some aspects, the method further includes providing, via the network interface, the current order to a store portal device of the restaurant. In some aspects, the method further includes receiving, via the network interface, an additional request for an additional digital menu of an additional restaurant from an additional customer.

### BRIEF DESCRIPTION OF THE DRAWINGS

FIG. 1 is a diagram illustrating an example of a communication system for facilitating the mobile-assisted digital waiter.

FIG. 2 is a block diagram illustrating an example of a mobile device for facilitating the mobile-assisted digital waiter.

FIG. 3 is a block diagram illustrating an example of a network device for facilitating the mobile-assisted digital waiter.

FIG. 4 is a block diagram illustrating an example of a system for facilitating the mobile-assisted digital waiter at multiple locations.

FIG. 5 is diagram illustrating an example of an operation of the mobile device to initiate the mobile-assisted digital waiter.

FIG. 6 is a diagram of an example of a restaurant implementing the mobile-assisted digital waiter.

FIGS. 7A-7J illustrate examples of user interfaces on a mobile device implementing the mobile-assisted digital waiter.

FIGS. 8A-8B illustrate examples of user interfaces on a mobile device for registering with the mobile-assisted digital waiter.

FIGS. 9A-9F illustrate examples of user interfaces on a store portal device implementing the mobile-assisted digital waiter.

FIG. 10 is a flow chart of a method for initiating the mobile-assisted digital waiter on a mobile device.

FIGS. 11A-11B are flow charts illustrating methods for facilitating a wait list request.

FIGS. 12A-12B are flow charts illustrating methods for sending an arrival notification.

FIGS. 13A-13B are flow charts illustrating methods for sending a seating notification to a mobile device.

FIGS. 14A-15B are flow charts illustrating methods for providing a valet service.

FIGS. 16A-16B are flow charts illustrating methods for providing a digital menu to a mobile device.

FIGS. 17A and 17B are flow charts illustrating methods for providing an order to a store portal device.

FIG. 18 is a flow chart illustrating a method for activating an alert on a mobile device to submit an order.

FIG. 19 is a flow chart illustrating a method for automatically submitting an order on a mobile device.

FIGS. 20A and 20B are flow charts illustrating methods for providing payment.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the present disclosure provide for a mobile-assisted digital waiter service implemented via a communication network. In some aspects of the disclosure, a mobile device may be configured with a mobile-assisted digital water application, which when executed by the mobile device, may assist a user/customer with the process of dining at a restaurant or ordering items for take-out from a restaurant. For example, the digital waiter application may enable a user/customer to view menus, place orders and pay their bill from their mobile device. In an aspect, the digital waiter application may enhance the dining experience for the user/customer by providing a customized digital menu to the user/customer, which includes at least one customized menu item generated based on a prior order history of the customer. In other aspects of the disclosure, a store portal device may be configured with a store portal device application, which when executed by the store portal device, may assist a restaurant with the process of seating customers, taking orders, securing payment, and servicing the needs of their customers. The digital waiter service may be enabled via a network device in communication with the mobile device and the store portal device. In an aspect, the network device may further offer support for multiple restaurants whether dining in or ordering take-out.

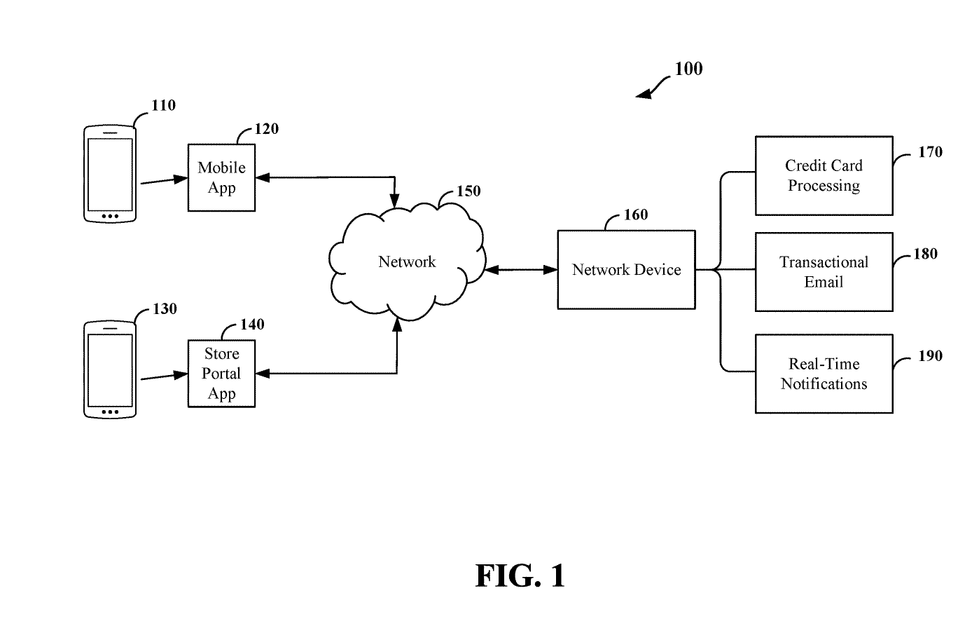

In order to illustrate some of the entities or devices described throughout the present disclosure, FIG. 1 is a diagram illustrating a generalized example of a system 100 for implementing a mobile-assisted digital waiter service. The system 100 includes a mobile device 110 in communication with a network device 160 via a communication network 150. The communication network 150 may include a wireless communication network and/or a wired communication network. For example, the communication network 150 may include one or more of a cellular network, a Wi-Fi network, a local area network (LAN), a wide area network (WAN), the Internet, and/or any other suitable communication network.

The mobile device 110 includes a mobile-assisted digital waiter application (Mobile App) 120, which when executed by the mobile device 110, facilitates interaction between a user/customer operating the mobile device 110 and the network device 160. In some examples, the digital waiter application 120 provides a user interface on a display of the mobile device 110 that enables a user/customer to perform one or more of the following actions:
Search for a particular restaurant
View a list of restaurants near the location of the mobile device;
Select a restaurant of interest;
View a list of services offered by the restaurant;
Select a service offered by the restaurant;
Request to be placed on a wait list at the restaurant;
Receive notification that seating is available at the restaurant;
View a digital menu generated for the restaurant in real-time;
View customized menu items within the digital menu;
Select one or more menu items from the digital menu;
Enter or select menu item modifications for the one or more selected menu items;
Place an order with the restaurant including the one or more selected menu items;
Page or request service from a waiter or other restaurant personnel;
Enter or select payment information to pay for the order; and/or
Request valet service.

The system 100 further includes one or more additional mobile devices, such as store portal device 130. The store portal device 130 includes a store portal application (Store Portal App) 140, which when executed by the store portal device 130, facilitates interaction between a restaurant user (e.g., a wait staff person, chef, hostess, valet attendant, manager, owner, or other restaurant personnel) operating the store portal device 130 and the network device 160. The store portal device 130 may further facilitate interaction with a point-of-sale (POS) system in the restaurant. In some examples, the store portal application 140 provides a user interface on a display of the store portal device 130 that enables a restaurant user to perform one or more of the following actions:
Receive/View notification of a request for a customer to be placed on a wait list at the restaurant;
Notify the customer that seating is available at the restaurant;
Receive/View an order from the customer;
Receive/View notification that the customer has paid for the order;
Receive/View a page or request from the customer;
View the status of one or more tables in the restaurant;
Create/update menu options, associated menu items, associated menu prices and associated menu art assets for use in generating a digital menu for a customer;
Manage employees;
Receive/View a request for valet service; and/or
Send/receive structured inputs to an existing point-of-sale (POS) system in order to facilitate automation of the “control panel” functionality.

The mobile device 110 may include, for example, a smartphone, a personal digital assistant, a tablet computer or other wireless device. The store portal device 130 may include, for example, a smartphone, a personal digital assistance, a tablet computer, a laptop computer, a desktop computer or any other wired or wireless device. The digital waiter application 120 and the store portal application 140 may each include a respective set of processor-executable instructions that can be read, interpreted, compiled, and/or executed by a respective processor on the mobile device 110/store portal device 130.

The network device 160 may be a physical computing device, such as a network server, that processes data and transmits and receives data via the communication network 150. The network device 160 is in communication with or may include various other processing systems, such as a credit card processing system 170, a transactional email processing system 180, and a real-time notifications processing system 190. In some examples, the credit card processing system 170 is configured to receive and process credit card information for customers of the restaurant, the transactional email processing system 180 is configured to generate and transmit electronic receipts to the customers, and the real-time notifications processing system 190 is configured to provide real-time publish and subscribe services to mobile devices 110 and store portal devices 130.

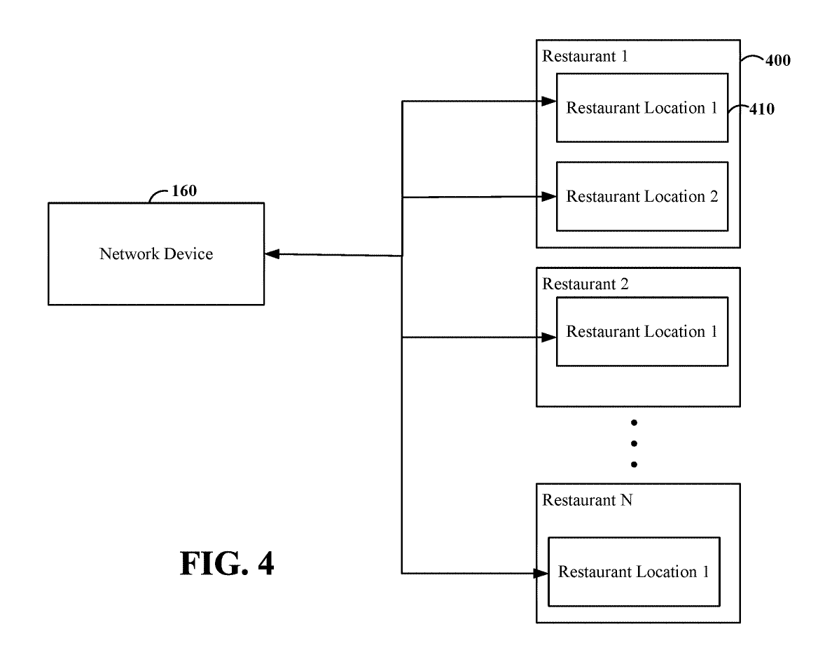

In one example, the network device 160 may be configured to facilitate the mobile-assisted digital waiter service for a single restaurant or restaurant location. In other examples, as shown in FIG. 4, the network device 160 may be configured to facilitate the mobile-assisted digital waiter service for multiple restaurants 400 (e.g., Restaurant 1, Restaurant 2 . . . Restaurant N) and/or locations 410 of a restaurant chain (e.g., Location 1 and Location 2 for Restaurant 1).

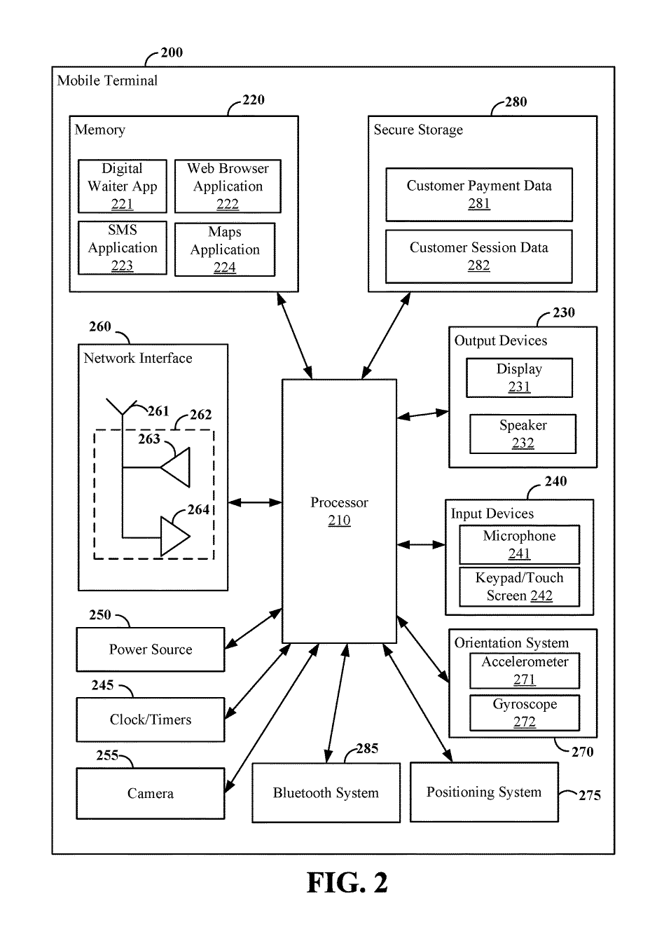

FIG. 2 is a block diagram illustrating an example of a hardware implementation of a mobile terminal 200 for facilitating the mobile-assisted digital waiter service. The mobile terminal 200 may correspond to, for example, the mobile device 110 or the store portal device 130 of FIG. 1. The mobile terminal 200 includes a processor 210, a memory 220, one or more output devices 230, one or more input devices 240 a power source 250, and a network interface 260.

The output devices 230 may include, for example, a display 231, a speaker 232, and/or other suitable device for providing output to a user of the mobile terminal 200. Input devices 240, may include, for example, a microphone 241, keypad and/or touch screen 242, and/or other suitable device for receiving input from a user of the mobile terminal 200. The network interface 260 includes an antenna 261 coupled to a wireless transceiver 262. The wireless transceiver 262 includes a transmitter 263 configured to transmit voice and/or data over an air interface via antenna 261 and a receiver 264 configured to receive voice and/or data via antenna 261.

The memory 220 includes a digital waiter app 221, which may correspond to the mobile-assisted digital waiter application (Mobile App) 120 or the store portal application (Store Portal App) 140 of FIG. 1. The memory 220 may further include, by way of example, but not limitation, a web browser application 222, a short message system (SMS) application 223, and a maps application 224. Each of the applications 221, 222, 223 and 224 may include a respective set of processor-executable instructions that can be read, interpreted, compiled, and/or executed by the processor 210.

The mobile terminal 200 may further include clock/timers 245, camera 255, orientation system 270, positioning system 275, secure storage 280, and/or Bluetooth system 285. The clock/timers 245 may include, for example, a local/slave clock that can be synchronized to a system/master clock within the communication network. In addition, clock/timers 245 may include one or more timers that may be configured to measure one or more time periods. The camera 255 may be configured to capture and display one or more images. The camera 255 may further store the images in, for example, memory 220.

The orientation system 270 may be configured to determine the orientation of the mobile terminal 200. For example, the orientation system 270 may determine the angle and rotation of the mobile terminal 200 relative to the ground. In an aspect, the orientation system 270 includes an accelerometer 271 that measures the rate of change of the mobile terminal 200 over distance and a gyroscope 272 that measures the tilt and rotation of the mobile terminal 200. The positioning system 275 may be configured to determine the location (i.e., Global Positioning System (GPS) coordinates) of the mobile terminal 200. For example, the positioning system 275 may include a GPS receiver and/or other circuitry configured to calculate the location of the mobile terminal 200.

The secure storage 280 may be configured to securely store data, such that the data is accessible to only the application that stored the data. Examples of data stored in the secure storage 280 may include customer payment data 281 and customer session data 282. The customer payment data 281 may include, for example, credit/debit card information entered by the user or captured by the camera 255 during execution of the digital waiter application 221. The customer session information 282 may include, for example, a prior order history of the user for one or more restaurants obtained during execution of the digital waiter application 221.

In an aspect of the disclosure, the processor 210 executes the digital waiter application 211, which may correspond to the Mobile App 120, to assist a user/customer in locating a restaurant, requesting the user/customer be added to a wait list, notifying the user/customer that a table has become available, placing an order, paying the bill, and/or requesting valet service. In some examples, the processor 210 executes the digital waiter application 221 to provide a user interface (e.g., graphical user interface) via the display 231 and keypad/touch screen 242 that enables a user to view restaurant information, select one or more options displayed on the display 231 and/or to enter information requested by the digital waiter application 221.

In one example, the processor 210 may execute the digital waiter application 221 to transmit a request for a digital menu of a restaurant to a network device via the network interface 260, receive the requested digital menu via the network interface 260, display the digital menu on the display 231 of the mobile terminal 200, and enable a user to select one or more menu items within the digital menu via the user interface for inclusion in an order to be transmitted to the network device via the network interface 260. The processor 210 may further execute the digital waiter application 221 to retrieve a prior order history (e.g., within customer session data 282) from the secure storage 280 and populate the digital menu with one or more customized menu items from the prior order history. The customized menu items may be added to the existing menu items in the digital menu or may be substituted in place of one or more menu items in the digital menu.

The processor 210 may further determine whether one or more of the menu items within the digital menu has a temporal visibility range associated therewith (e.g., as metadata within a file containing the possible menu items for the digital menu), compare current temporal information (e.g., a current date, day of week, time of day and/or season) with the respective temporal visibility ranges (date range, day(s) of week range, time of day range and/or season range), and render a subset of menu items having the current temporal information in the respective temporal visibility range on the display 231 as the digital menu. The processor 210 may further customize the digital menu based on the selected menu class. For example, the user/customer may have selected a dine-in menu class, a take-out menu class, a delivery menu class, a kids menu class, a chefs menu class, and/or a menu from a particular location of a restaurant (to enable different locations to customize their menus), and the processor 210 may select menu items for inclusion in the displayed digital menu that correspond to the selected menu class (e.g., as determined from metadata in a file containing the possible menu items for the digital menu).

In another example, the processor 210 may execute the digital waiter application 221 to display a list of restaurants near the mobile terminal 200. For example, the processor 210 may instruct (send an instruction to) the positioning system 275 to calculate the current location of the mobile terminal 200, transmit the current location to a network device via the network interface 260, receive the list of restaurants from the network device via the network interface 260, and include the list of restaurants in a user interface displayed on display 231. In other examples, the processing system 210 may execute the maps application 224 to determine a list of restaurants near the location of the mobile terminal 200. The processor 210 may further calculate an estimated time of arrival to a selected restaurant based on the current location of the mobile device and the location of the restaurant, and transmit the estimated time of arrival to the restaurant either together with or subsequent to sending a request for the user/customer to be added to a wait list at the selected restaurant.

In addition, the processor 210 may further continuously or nearly continuously transmit the location of the mobile terminal 200 to the network device via the network interface 260 to enable the network device to determine when the mobile terminal 200 is within a predetermined distance (i.e., a “fenced” distance in a geo-fencing application) of the restaurant. In other examples, the processor 210 may compare the current location of the mobile terminal 200 to the “fenced” distance and transmit an arrival notification to the network device via the network interface 260 when the current location of the mobile device is within the “fenced” distance. The arrival notification may serve to inform the restaurant that the user/customer has arrived when the user/customer has been placed on a wait list at the restaurant.

In another example, the processor 210 may execute the digital waiter application 221 to determine a table number of a table at which the user/mobile terminal 200 is seated. For example, the processor 210 may instruct the Bluetooth system 285 to initiate wireless communication with one or more proximity beacons placed on/under the table to identify the table number of the table at which the mobile device is located.

In another example, the processor 210 may execute the digital waiter application 221 to prompt a user to submit their order when complete. For example, the processor 210 may display a list of selected menu items on the display 231 and provide a prompt, such as a “Submit Order” button, on the user interface for the user to select. As another example, the processor 210 may initiate a timer 245 upon receiving a menu item selection from the user via the user interface. If the timer 245 expires prior to the processor 210 receiving another menu item selection or a “submit order” instruction from the user via the user interface, the processor 210 may provide a visual and/or audible alert to the user via the display 231 and/or speaker 232.

In another example, the processor 210 may execute the digital waiter application 221 to automatically submit an order to the network device. For example, upon receiving at least one menu item selection from the user via the user interface, the processor 210 may instruct the orientation system 270 to obtain orientation information from, for example, the accelerometer 271 and/or gyroscope 272, and determine whether the mobile device is stationary (i.e., placed upon a flat surface, such as a tabletop) based on the orientation information. In response to the orientation system 270 providing an indication to the processor 210 that the mobile device is stationary, the processor 210 may further initiate a timer 245. If the timer 245 expires prior to the processor 210 receiving another menu item selection or a “submit order” instruction from the user via the user interface, the processor 210 may automatically transmit the order containing the selected menu items to the network device via the network interface 260.

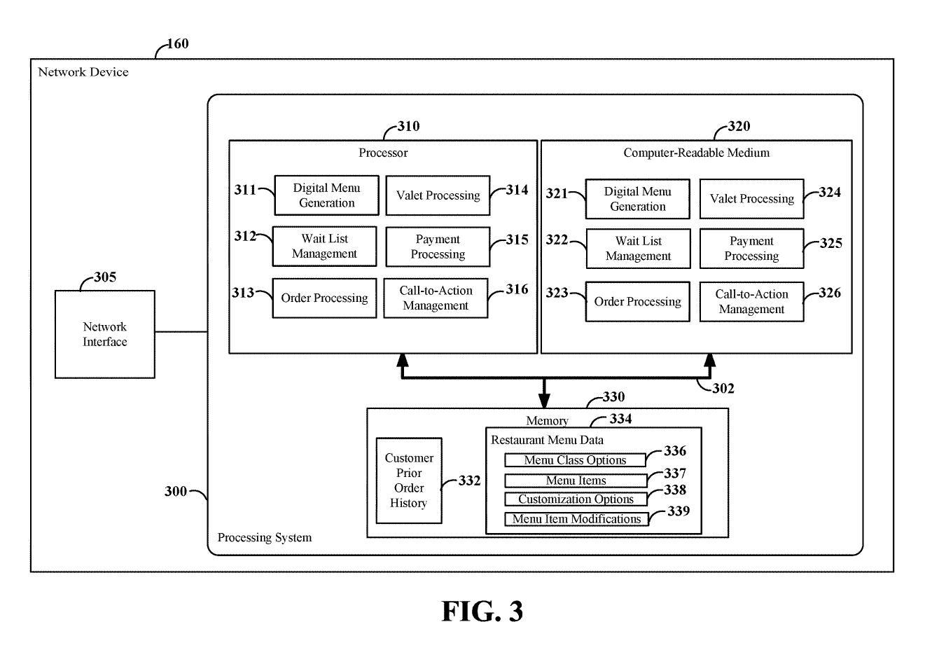

In another example, the processor 210 may execute the digital waiter application 221 to provide payment for an order. For example, the processor 210 may access the secure storage 280 to retrieve customer payment data 281 (e.g., credit/debit card information) and securely transmit the customer payment data 281 to the network device via the network interface 260. The network device may process the customer payment data 281, as discussed below in connection with FIG. 3, or forward the customer payment data 281 to the POS system for processing.

In another example, the processor 210 may execute the digital waiter application 221 to request valet services. For example, the processor 210 may receive a request to valet a vehicle at a restaurant from the user via the user interface, transmit the valet request (possibly together with the current location of the mobile device) to the network device via the network interface 260, receive a valet ticket number for the valet from the network device via the network interface 260 and display the valet ticket number on the display 231. In other examples, the valet ticket number may be received as an SMS message via the SMS application 223.

As another example, the processor 210 may receive a confirmation message from the network device via the network interface 260 when payment has been completed for an order, and in response, provide a prompt on the display 231 for the user to request their vehicle using the valet ticket number. In response to receiving a user selection via the user interface to retrieve their vehicle, the processor 210 may transmit a valet request including the valet ticket number to the network device via the network interface 260.

In an aspect of the disclosure, the processor 210 executes the digital waiter application 211, which may correspond to the Store Portal App 140, to assist a restaurant wait staff person or other restaurant personnel to view the status of each table in the restaurant, view orders placed by customers, view take-out or “to go” orders, edit orders, clear orders, arrange for payment of orders, view pages or requests from customers, assign wait staff to tables, manage menus, manage wait lists, and manage employees. In one example, the processor 210 may execute the digital waiter application 221 to enable restaurant personnel to add, remove, or modify menu items, create menu classes, assign menu items to menu classes, and/or select temporal visibility ranges (e.g., visibility date ranges, times of day, days of week and/or seasons) for the menu items. In addition, the processor 210 may execute the digital waiter application 221 to enable restaurant personnel to add selectable menu item modifications to the menu items and/or configure one or more menu items to include a fillable field that may be used by the customer to modify the menu item. The entered/modified menu items may then be transmitted to the network device via the network interface 260 for use by the network device in generating digital menus for the restaurant. The processor 210 may further execute the digital waiter application 221 to receive structured inputs (order information) from a network device and forward the order information to an existing POS system in the restaurant.

In another example, the processor 210 may execute the digital waiter application 221 to enable a hostess to view and manage a wait list. For example, the processor 210 may receive a wait list request from a customer via the network interface 260 and automatically include the customer on a wait list viewable on the display 231 of the mobile terminal 200. The wait list request may include various wait list information that may be included on the wait list. Examples of wait list information include the customer name, number of people in the customer's party, a desired time of arrival or an estimated time of arrival and/or other information that may be requested by the restaurant for the wait list. The processor 210 may further receive an arrival notification when the customer arrives at the restaurant and update the wait list with the arrival information. In addition, the processor 210 may receive a selection by the hostess of a particular customer on the wait list to be seated, and in response to the customer selection, transmit a seating notification to the customer via the network interface 260.

The processor 210 may include one or more processors 210. Examples of processors 210 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 210, as utilized in the mobile terminal 200, may be used to implement any one or more of the processes described herein. The memory 220 and secure storage 280 may each be, for example, a non-transitory computer-readable medium. Such a non-transitory computer-readable medium includes, by way of example, a magnetic storage device (e.g., hard disk or magnetic strip), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, and/or any other suitable medium for storing data, software and/or instructions that may be accessed and read by the processor 210.

FIG. 3 is a block diagram illustrating an example of a hardware implementation of a network device 160 for facilitating the mobile-assisted digital waiter service. The network device 160 includes a processing system 300 and a network interface 305 for communicating with other apparatus (e.g., mobile device 110, store portal device 130 and/or point-of-sale (POS) systems) via a transmission medium. For example, the network interface 306 may be coupled to the communication network via a wired or wireless link.

In this example, the processing system 314 may be implemented with a bus architecture, represented generally by the bus 302. The bus 302 may include any number of interconnecting buses and bridges depending on the specific application of the processing system 300 and the overall design constraints. The bus 302 links together various circuits including one or more processors (represented generally by the processor 310), a memory 330, and computer-readable media (represented generally by the computer-readable medium 320). The bus 302 may also link various other circuits such as timing sources, peripherals, voltage regulators, and power management circuits, which are well known in the art, and therefore, will not be described any further.

The processor 310 is responsible for managing the bus 302 and general processing, including the execution of software stored on the computer-readable medium 320. The software, when executed by the processor 310, causes the processing system 300 to perform the various functions described below for any particular apparatus. The computer-readable medium 320 may also be used for storing data that is manipulated by the processor 310 when executing software.

In some aspects of the disclosure, the processor 310 may include digital menu generation circuitry 311, configured to generate one or more digital menus for one or more restaurants (or restaurant locations). For example, the digital menu generation circuitry 311 may utilize restaurant data 334 maintained within the memory 330 to generate the digital menus. The restaurant data 334 for each restaurant may include, for example, menu class options 336 (e.g., a dine-in menu option, a take-out menu option, a delivery menu option, a restaurant location menu option, a kids menu option, a chefs menu option, etc.), a plurality of menu items 337 associated with each of the menu class options 336, one or more customization options 338 (e.g., time of day, day of week, date range, season, etc.) set by the restaurant for one or more of the menu items 337 and one or more menu item modifications 339 associated with one or more of the menu items 337.

In an exemplary operation, the digital menu generation circuitry 311 may receive a request for a digital menu of a particular restaurant from a customer via the network interface 305 and access the memory 330 to retrieve the restaurant data 334 for the restaurant. The digital menu generation circuitry may further receive a selected menu class option 336 from the customer (e.g., dine-in menu, take-out menu, kids menu, delivery menu, chefs menu, menu for a particular location of a restaurant, etc.), and based on the selected menu class option 336, the digital menu generation circuitry 311 may generate a digital menu containing the menu items 327 associated with the selected menu class option 336. The digital menu generation circuitry 331 may then compare the customization options 338 with the menu items in the digital menu and filter/modify the menu items based on the customization options 338.

In some examples, the digital menu generation circuitry 331 determines a subset of menu items 337 that match any applicable customization options 338 set by the restaurant. For example, the digital menu generation circuitry 331 may compare current temporal information (e.g., a current date, day of week, time or season) with temporal visibility information (e.g., a date range, time of day range, day(s) of week range and/or season range) for one or more of the menu items to determine a subset of menu items having the current temporal information in the respective temporal visibility range, and include only the subset of menu items in the digital menu.

The customization options 338 may further indicate that certain menu items be “recommended” or “on special” at certain times or on certain days. For example, during “Happy Hour,” certain menu items may be discounted and included in a separate section of the menu. As another example, one or more menu items may be included in a “Specials of the Day” section of the digital menu. The customization options 338 may further include keywords, such as an emotional state or ethnic food type, associated with one or more of the menu items. For example, the customer may enter/select a particular keyword (i.e., emotional state or desired ethnic food type) and the digital menu generation circuitry 311 may include those menu items matching the entered keyword for inclusion in the digital menu.

The digital menu generation circuitry 311 may further add one or more menu item modifications 339 to one or more of the menu items in the digital menu. For example, the digital menu generation circuitry 311 may add selectable options (e.g., toppings, salad dressings, condiments, meat temperature, etc.) to the menu items and/or include a fillable filed that enables the customer to enter specific instructions for the menu item (e.g., instructions to add ingredients or remove ingredients, and/or instructions on allergy or food restrictions, such as gluten-free, dairy-free, etc.). The menu item modifications 339 allows for a large variation in customization and automatic pricing updates based on the selected menu item modifications. Any additions beyond those provided in selectable fields (i.e., additions included in a fillable field) may require the wait staff person to update the price manually. In some examples, the price change may be captured by the store portal device and provided to the network device 160 via the network interface 305 for storage within the menu item modifications to enable future similar modifications to be automatically updated with the correct price.

The digital menu generation circuitry 311 may further access a prior order history 332 of the customer for the particular restaurant or other restaurants and identify one or more customized menu items previously ordered by the customer. The customized menu items may include, for example, one or more previously selected/entered menu item modifications. The digital menu generation circuitry 311 may add the customized menu items to the digital menu or may substitute (replace) one or more menu items in the digital menu with the one or more customized menu items. For example, instead of “hamburger,” the digital menu can include “Joe's hamburger,” which includes the customer “Joe's” previously ordered menu item modifications to the hamburger (e.g., “Hamburger, Prepared Medium, with Cheddar Cheese”).

The digital menu generation circuitry 311 may further interface with restaurant personnel via a store portal device and the network interface 305 to add, remove and/or update the menu class options 336, menu items 337, customization options 338 and menu item modifications 339. The digital menu generation circuitry 311 may operate in coordination with digital menu generation software 321.

The processor 310 may further include wait list management circuitry 312, configured to assist restaurants in managing their wait lists. For example, the wait list management circuitry 312 may receive a request from a customer via the network interface 305 to be added to a wait list for a particular restaurant. The wait list request may include (or the customer may be prompted to provide), for example, the name of the customer, the number of people in the customer's party, a desired time of arrival and/or an estimated time of arrival. The wait list management circuitry 312 may then forward the wait list request to a store portal device of the restaurant to add the customer to the restaurant's wait list. The wait list management circuitry 312 may further store the wait list request in a wait list record associated with the customer for further processing.

For example, the wait list management circuitry 312 may further receive GPS coordinates from a mobile device of the customer at regular intervals via the network interface 305 and compare the GPS coordinates to a predetermined distance from the restaurant (e.g., a “fenced” distance) to determine when the mobile device is within the predetermined distance from the restaurant. Upon determining that the mobile device is within the predetermined distance from the restaurant, the wait list management circuitry may transmit an arrival notification to the store portal device maintaining the wait list at the restaurant indicating that the customer has arrived. In other examples, the wait list management circuitry 312 may simply receive an arrival notification message from the customer (e.g., either entered by the customer on the mobile device or automatically transmitted from the mobile device when the mobile device determines that it is within the predetermined distance from the restaurant), and transmit the arrival notification to the store portal device at the restaurant. Upon transmitting the arrival notification to the store portal device, the wait list management circuitry 312 further updates the wait list record of the customer with the arrival status of the customer.

The wait list management circuitry 312 may further receive a seating notification from the store portal device at the restaurant indicating that a table is ready for the customer, and therefore, the restaurant may now seat the customer and his/her party. The wait list management circuitry 312 may then transmit the seating notification to the mobile device of the customer and update the wait list record of the customer accordingly. In some examples, the customer may desire additional time to be seated (i.e., if the entire party has not yet arrived), and transmit an additional time request to the network device 160. In this example, the wait list management circuitry 312 may receive the additional time request, transmit the additional time request to the store portal device and update the wait list record associated with the customer accordingly. The additional time request may include a specific time, or may be associated with a default time set by the restaurant and/or network device. The wait list management circuitry 312 may operate in coordination with wait list management software 322.

The processor 310 may further include order processing circuitry 313, configured to process orders submitted by customers. For example, the order processing circuitry 313 may receive an order including one or more selected menu items from a customer via the network interface 305. The order may further include one or more selected/entered menu item modifications, along with a table number (if applicable). For example, if the customer requested a take-out or delivery menu option or if the customer entered that the order was for take-out or delivery, a table number would not be included with the order. The order processing circuitry 313 may then assign an order number to the order and transmit the received order (including the order number, selected menu items/menu item modifications, and table number) to the store portal device of the restaurant, which may then forward the received order to the POS system in the restaurant. In other examples, the order processing circuitry 313 may transmit the received order directly to the POS system via structured standardized data formats. The order number may further be provided back to the mobile device of the customer. In addition, the order processing circuitry 313 stores the order in an order record associated with the customer. The order processing circuitry 313 may further store any customized menu items (e.g., selected menu items containing selected/entered menu item modifications) within the prior order history 322 for the customer.

The order processing circuitry 313 maintains the order record for the customer until the order is closed out. For example, the order processing circuitry may maintain the order record until payment confirmation is received from the store portal device or payment processing circuitry 315 or an order close-out instruction is received from the store portal device or mobile device of the customer (i.e., if the customer decides to delete the order or leave the restaurant before eating). If the order processing circuitry 313 receives one or more additional selected menu items before the order is closed out, the order processing circuitry 313 may update the order record for the customer and forward the additional selected menu items to the store portal device, which may then further provide the updates to the POS system. The order processing circuitry 313 may further query POS systems for prior order information to facilitate cloud-based analytics. The order processing circuitry 313 may operate in coordination with order processing software 323.

The processor 310 may further include valet processing circuitry 314, configured to manage valet services. For example, the valet processing circuitry 314 may receive a valet request from a mobile device of a customer via the network interface 305. In one example, the valet request includes GPS coordinates of the mobile device to enable the valet processing circuitry 314 to determine the closest valet stand to the mobile device. In other examples, the valet request may include a selected restaurant or may be received after an arrival notification at a restaurant has been sent, thus enabling the valet processing circuitry 314 to determine the valet stand associated with the restaurant. The valet request may further include vehicle information (i.e., the make, model, year, and/or vehicle identification number) associated with the vehicle to be valeted. The vehicle information may also be maintained within memory 330 and retrieved by the valet processing circuitry 314 upon receiving the valet request.

The valet processing circuitry 314 may then generate a digital valet ticket for the customer's vehicle and transmit a valet message including the digital valet ticket to the mobile device of the customer. The valet message may be sent, for example, as an SMS message to the mobile device of the customer. In one example, the customer may then show the valet the digital valet ticket and leave their vehicle with the valet. In other examples, the valet processing circuitry 314 further transmits the valet ticket number, along with the vehicle information and customer information (i.e., customer name and cell phone number) to the store portal device of the valet attendant and the customer may then simply leave the keys at the valet stand.

The valet processing circuitry 314 may further receive payment confirmation from, for example, the payment processing circuitry 315, or an order close-out instruction, and then provide a prompt to the mobile device of the customer via the network interface 305 for the user to request their vehicle using the previously generated valet ticket number. Upon receiving a valet request from the customer indicating that the vehicle should be requested, the valet processing circuitry 314 may then transmit the valet request including the valet ticket number to the store portal device operated by the valet attendant instructing the valet attendant to retrieve the customer's vehicle. In other examples, the valet processing circuitry 314 may receive a valet request from the mobile device of the customer prior to receiving payment confirmation, retrieve the valet ticket number associated with the customer and transmit the valet request to the store portal device of the valet attendant. The valet processing circuitry 314 may operate in coordination with valet processing software 324.

The processor 310 may further include payment processing circuitry 315, configured to facilitate and/or monitor payment by the customer for the order. For example, the payment processing circuitry 315 may receive a payment request from a mobile device of a customer via the network interface 305 to pay for one or more selected menu items in an order placed by the customer with a restaurant. The payment request may include the total amount for an order, along with any tip entered by the customer. In other examples, the tip amount may be a default tip percentage that is calculated by the digital waiter application on the mobile device, on the store portal device or by the payment processing circuitry 315 (and then provided back to the mobile device via the network interface for confirmation). In an aspect, the store portal device may send service fee configuration information (i.e., a default tip percentage) to the network device 160 for a particular customer or multiple customers, and the payment processing circuitry 315 may then send the service fee configuration information to the mobile device to be used by the digital waiter application when calculating the total amount due.

The payment request may also indicate specific items to be paid, and whether those items are to be paid by the customer or a guest of the customer. This enables the customer to easily split the check between different parties at the table. If, for example, the payment request indicates that the customer is paying for two of four items in the order, the payment request may further include credit card information of the customer to initiate payment of those two items. The payment processing system may then receive an additional payment request for the remaining two items with guest credit card information associated with a guest of the customer. The additional payment request may be generated from the customer's mobile device (e.g., the guest may enter their credit card information into the customer's mobile device) or from the guest's mobile device. For example, the guest may execute the digital waiter application on their mobile device and submit the order number to the network device to select the remaining two items for payment. As another example, the customer may enter the cell phone number of the guest, and the payment processing circuitry 315 may then generate an SMS message to the guest's mobile device with a link to download the digital waiter application and/or launch the digital waiter application with the order number of the order to initiate payment.

The payment request may further indicate the type of payment desired by the customer. For example, the payment request may indicate that the customer will be paying the waiter directly or paying with cash, and the payment processing circuitry 315 may then generate and transmit a payment notification to the store portal device of the restaurant notifying the wait staff person to collect payment from the customer. In this example, once payment has been collected at the restaurant, the wait staff personnel may update the status of the order on the store portal device, which may then transmit a payment complete notification to the payment processing circuitry 315. In another example, the payment request may indicate that the customer will be paying by credit card and include the credit card information of the customer. The payment processing circuitry 315 may then send the credit card information to a credit card processing system (as shown in FIG. 1) for processing. If successful, the payment is applied to the total amount due and a transaction result is sent to the mobile device and the store portal device. The same procedure is applied to any guest credit card information that is provided to the network device 160. Additional payment types may also be supported, depending on the restaurant, including, for example, PayPal™ or Apple Pay™.

Once the payment processing circuitry 315 determines that payment has been successfully completed, the payment processing circuitry 315 may transmit a payment complete notification to the mobile device of the customer for display thereon. If the customer desires a receipt, the payment processing circuitry 315 may further receive a receipt request from the customer. The receipt request may indicate, for example, whether the customer would like a printed receipt or an emailed receipt. If the receipt request indicates the customer would like a printed receipt, the payment processing circuitry 315 may send a receipt notification to the store portal device requesting the wait staff person print a receipt (or receipts if the check was split) and provide the receipt(s) to the customer. In another example, the payment processing circuitry 315 may send a message to a WiFi enabled network printer to automatically print the receipt(s). If the receipt request indicates the customer would like an emailed receipt, the payment processing circuitry 315 may further generate the receipt and transmit the receipt to the transactional email processing system to transmit the receipt to the customer's email address. The customer's email address may be provided with the receipt request or retrieved from a customer profile maintained, for example, in memory 330. The payment processing circuitry 315 may operate in coordination with payment processing software 325.

The processor 310 may further include call-to-action management circuitry 316, configured to notify wait staff personnel that the customer requires service. For example, the call-to-action management circuitry 316 may receive a call wait staff request from the mobile device of the customer via the network interface 305 and transmit the call wait staff request to the store portal device of the restaurant. The call wait staff request may be a general request for wait staff personnel to go to the customer's table or may be a specific request for a particular service desired by the customer. For example, the request may indicate that the customer desires a refill, needs utensils, spilled a drink, or other predefined or customer entered call-to-action item. The call-to-action management circuitry 316 may operate in coordination with call-to-action management software 326.

Examples of processors 310 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 310, as utilized in the network device 160, may be used to implement any one or more of the processes described herein.

One or more processors 310 in the processing system 300 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 320. The computer-readable medium 320 may be a non-transitory computer-readable medium. A non-transitory computer-readable medium includes, by way of example, a magnetic storage device (e.g., hard disk or magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 310 may reside in the processing system 300, external to the processing system 300, or distributed across multiple entities including the processing system 300. The computer-readable medium 320 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

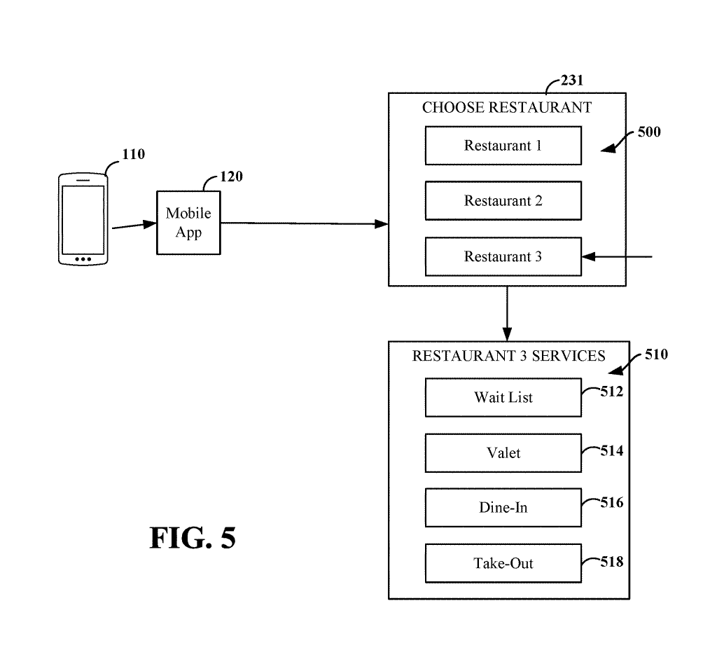

FIG. 5 illustrates an example of an operation of the mobile device 110 to initiate the mobile-assisted digital waiter service. As can be seen in FIG. 5, when the mobile-assisted digital waiter application (Mobile App) 120 on the mobile device is launched, a user interface 500 is provided on the display 231 containing a list of restaurants (Restaurant 1, Restaurant 2, and Restaurant 3) for the user to select from. The restaurants included in the list of restaurants may be located near the mobile device or may be a list of favorite restaurants entered by the customer or determined based on previous operations of the digital waiter application 120. In other examples, the user may enter the name of a desired restaurant of choice, and the list may include those restaurants most closely matching the entered restaurant name. If the user, for example, selects Restaurant 3, the digital waiter application 120 transitions to a service user interface 510 containing a list of selectable services offered by Restaurant 3. For example, the services may include a Wait List service 512, a Valet service 514, a Dine-In service 516 and a Take-Out service 518. The Dine-In service 516 may be selected, for example, if the user is at the restaurant location and has been seated.

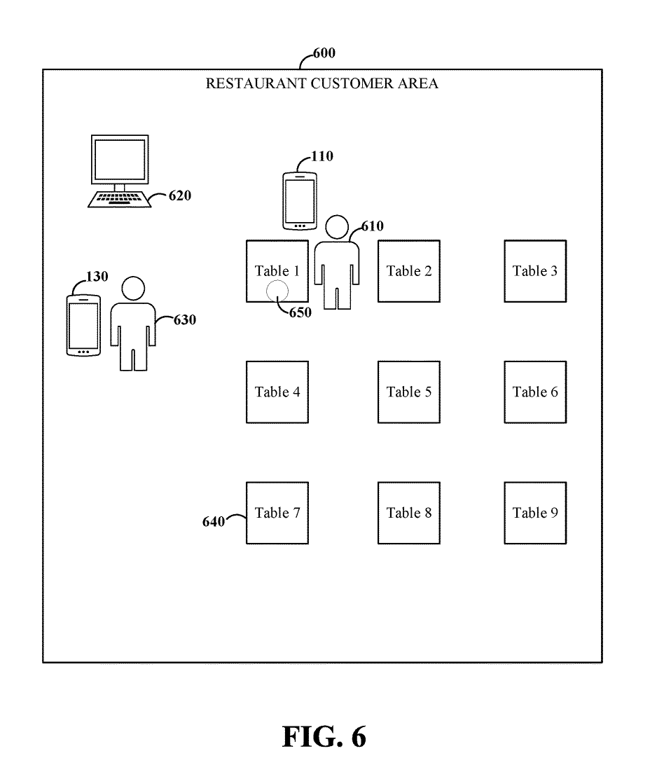

FIG. 6 illustrates an example of a restaurant implementing the mobile-assisted digital waiter service. As shown in FIG. 6, a restaurant customer area 600 of the restaurant includes a plurality of tables 640, a point of sale device 620 and a store portal device 130 operated by a wait staff person 630. A customer 610 operating a mobile device 110 having the Mobile App thereon is seated at Table 1. The customer may launch the Mobile App to view a digital menu of the restaurant and submit an order to the restaurant. The order may include the table number, as entered by the customer, or determined via communication between the mobile device and one or more proximity beacons 650 on the table. The proximity beacon 650 may include, for example, a small ARM computer combined with a Bluetooth module, powered by a battery. Once submitted, the order will appear on the display of the store portal device 130. In one example, the wait staff person 630 may then enter the order into the point of sale device 620. In other examples, the order may be transmitted (automatically or upon receiving an instruction) from the network device to the point of sale device 620 or from the store portal device 130 to the point of sale device 620 using structured standardized data formats.

The wait staff person 630 may further make modifications to the order via the store portal device 130, such as a price change or menu item change after discussing the change(s) with the customer 610. The wait staff person 630 may further accept cash payments, print receipts and handle other matters related to the order using the point of sale device 620.

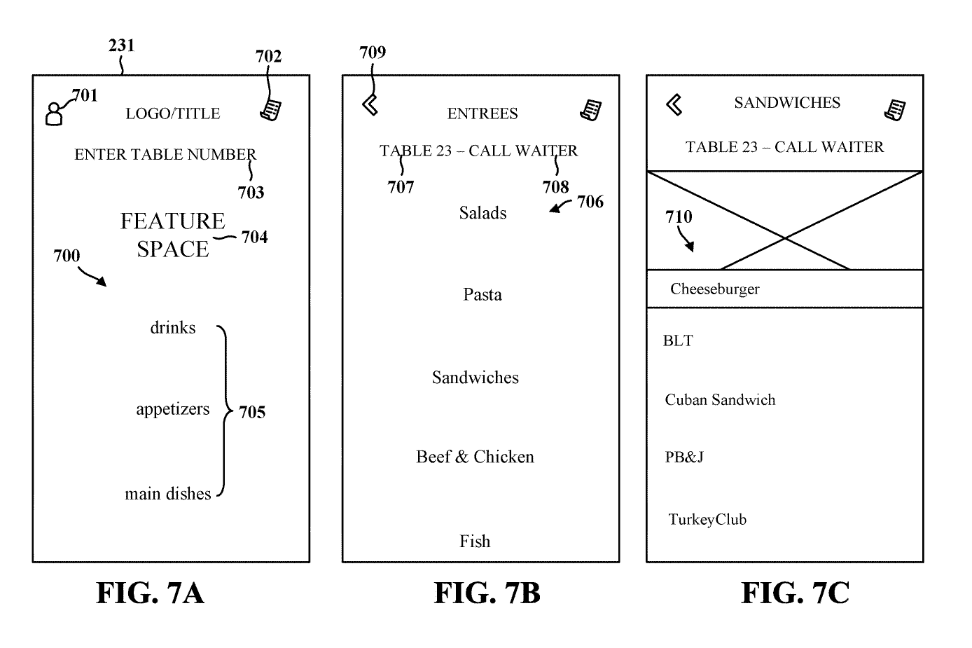

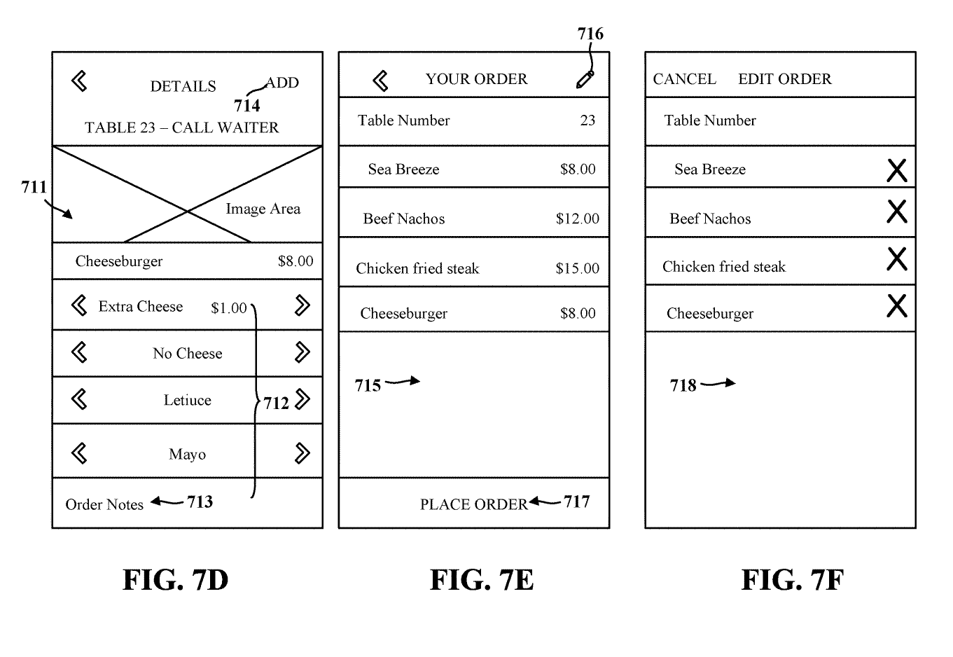

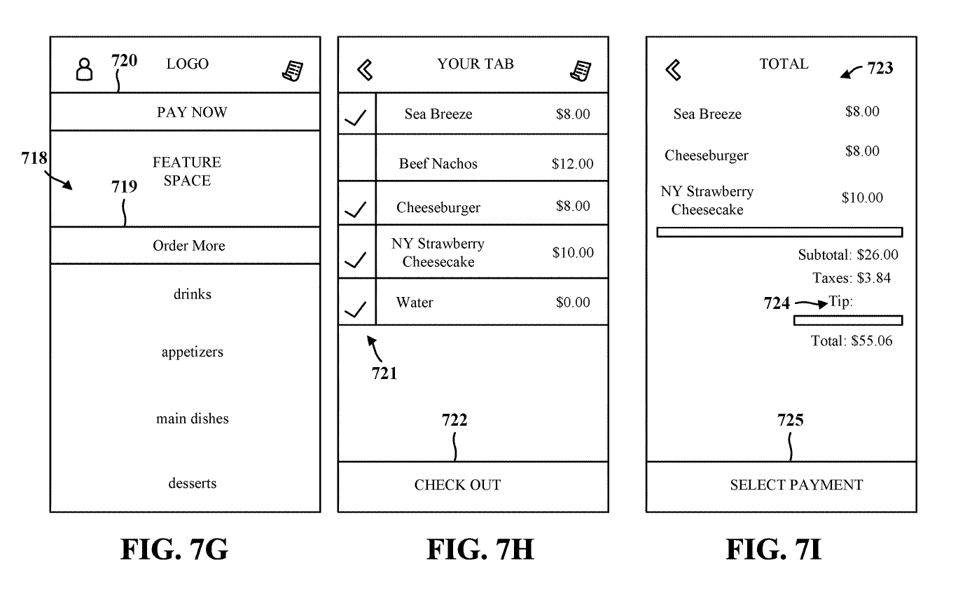

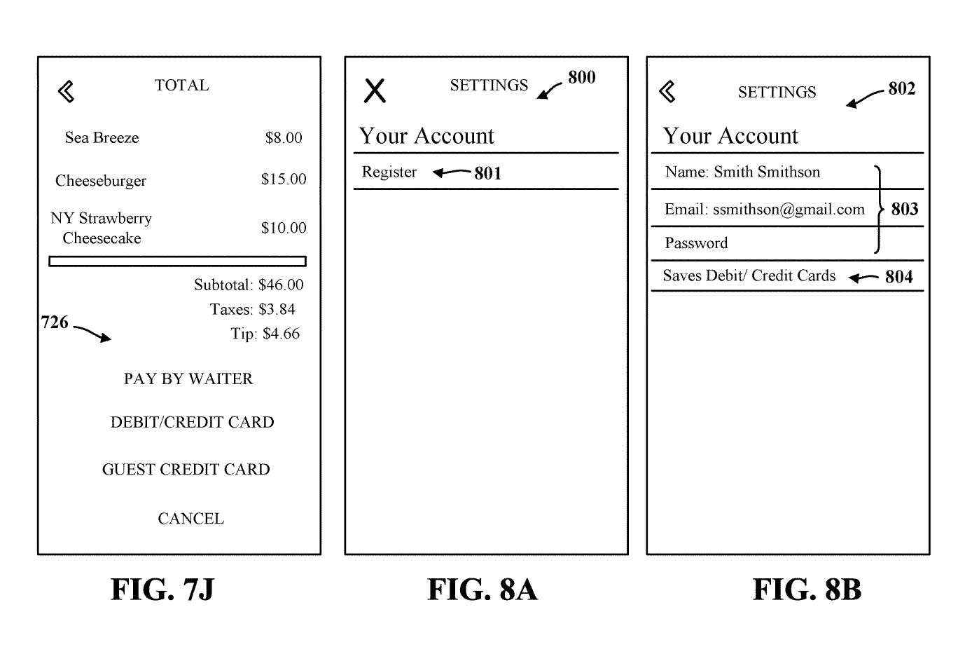

FIGS. 7A-7J illustrate examples of user interfaces on a mobile device implementing the mobile-assisted digital waiter service. For example, the mobile device may execute the Mobile App 120 (shown in FIG. 1), to provide the user interfaces shown in FIGS. 7A-7J.

FIG. 7A illustrates a top level menu user interface 700 displayed on a display 231 of the mobile device. The top level menu user interface 700 includes a feature space 704 supporting selectable menu item categories 705 (e.g., drinks, appetizers, main dishes, etc.). The user interface 700 further includes a user profile button 701, which when selected by the user, causes the Mobile App to transition from the top-level menu user interface 700 to a user profile user interface, where the user can register with the mobile-assisted digital waiter service or manage their registration information, as described in more detail below with respect to FIGS. 8A and 8B. In addition, the top-level menu user interface 700 shown in FIG. 7A further includes an order button 702, which when selected by the user, causes the Mobile App to transition from the top-level menu interface 700 to an order user interface, where the user can view the current order. The top-level menu user interface 700 further includes an “Enter Table Number” button 703, which allows the user to enter the number of the table at which the customer is seated.

FIG. 7B illustrates a detailed menu user interface 706 including main dish food categories displayed after the user selects the “Main Dishes” button in the top level user interface 700, as can be seen in FIG. 7A. The detailed menu user interface 706 further displays the table number 707 as entered by the user or determined by the mobile device and provides a “Call Waiter” button 708 to enable the user to request services of the wait staff personnel. A back button 709 is further provided at the top of the user interface 706 to allow the user to go back to the top-level menu user interface 700.

FIG. 7C illustrates another detailed menu user interface 710 including a list of menu items under the “Sandwiches” food dish category selected by the user via the user interface 706 shown in FIG. 7B. The menu item list further includes a respective price for each of the sandwich options. Upon selecting, for example, the “Cheeseburger” menu item via user interface 710, a menu item details user interface 711 is displayed, as shown in FIG. 7D. The menu item details user interface 711 includes a list of menu item modifications 712 to choose from and an order notes section 713 that allows the user to enter specific modifications/customizations to the selected menu item (e.g., “Cheeseburger”). A user may select one or more of the predefined menu item modifications 712 by, for example, swiping left or right on each of the menu item modifications 712. An optional image of the selected menu item “Cheeseburger” may also be included on the menu item details user interface 711. Once all of the menu item modifications have been selected via selection buttons 712 and/or entered via order notes section 713, the user may select (i.e., click or tap) the “Add” button 714 at the top of the menu item details user interface 711 to add the selected menu item to the order.

Once the user is finished entering/selecting all of the desired menu items, the user may click on or tap the order button, for example, from one of the user interfaces 700, 706 or 710 shown in FIGS. 7A-7C, to view an order user interface 715, as shown in FIG. 7E. The order user interface 715 includes a list of each selected menu item and its associated price. To submit the order, the user may click on or tap a “Place Order” button 717 at the bottom of the order user interface 715. However, if any changes are desired, the user may click on or tap an edit button 716 at the top of the order user interface 715 to transition to an edit order user interface 718, as shown in FIG. 7F.

After the order has been submitted, the digital waiter application may transition to a re-order or pay user interface 718, as shown in FIG. 7G, that provides the user with the option to order additional items via an “Order More” button 719 or to pay for their order via a “Pay Now” button 720. If the user selects the “Order More” button 719, the Mobile App will transition back to the top-level menu user interface 700 shown in FIG. 7A. However, if the user selects the “Pay Now” button 720, the Mobile App will transition to an order tab user interface 721, as shown in FIG. 7H, that includes a list of all of the selected menu items and their associated prices in the order. In the order tab user interface 721, the user may click on or tap a “Check Out” button 722 to initiate payment of the order.

As shown in FIG. 7I, a total user interface 723 includes the subtotal of all menu items ordered, along with any applicable taxes. The total user interface 723 may further include a tip fillable field 724 that allows a user to enter a tip. In some examples, the tip fillable field 724 may be omitted or may be automatically populated with a tip percentage set by the restaurant. For example, since the mobile-assisted digital waiter service performs many of the traditional tasks of wait staff personnel, the restaurant may choose to reduce the number of wait staff personnel and/or arrange for wait staff wages that do not account for tipping.

Once the tip has been entered and/or the user approves of the total, the user may click on or tap a “Select Payment” button 725, which causes the Mobile App to transition to a payment user interface 726, as shown in FIG. 7J, which provides the user with payment options, such as “Pay By Waiter,” “Debit/Credit Card,” “Guest Credit Card,” and/or other payment options. If, for example, the user clicks on or taps the “Debit/Credit Card” or “Guest Credit Card” button, the Mobile App may transition to another user interface for the user/guest to enter their credit card information. In other examples, the Mobile App may access stored customer payment data containing the debit/credit card information of the user and submit the stored customer payment data to the network device pay for the order.

FIGS. 8A-8B illustrate examples of user interfaces provided on a mobile device by the Mobile App for registering with the mobile-assisted digital waiter service. FIG. 8A illustrates a registration user interface 800, which provides a “Register” button 801 allowing a user to register with the mobile-assisted digital waiter service. FIG. 8B illustrates an account settings user interface 802, providing account fillable fields 803 for a user to enter their personal information, along with a payment information button 804 enabling a user to enter their customer payment data (e.g., debit/credit card information) for storage in the secure storage.

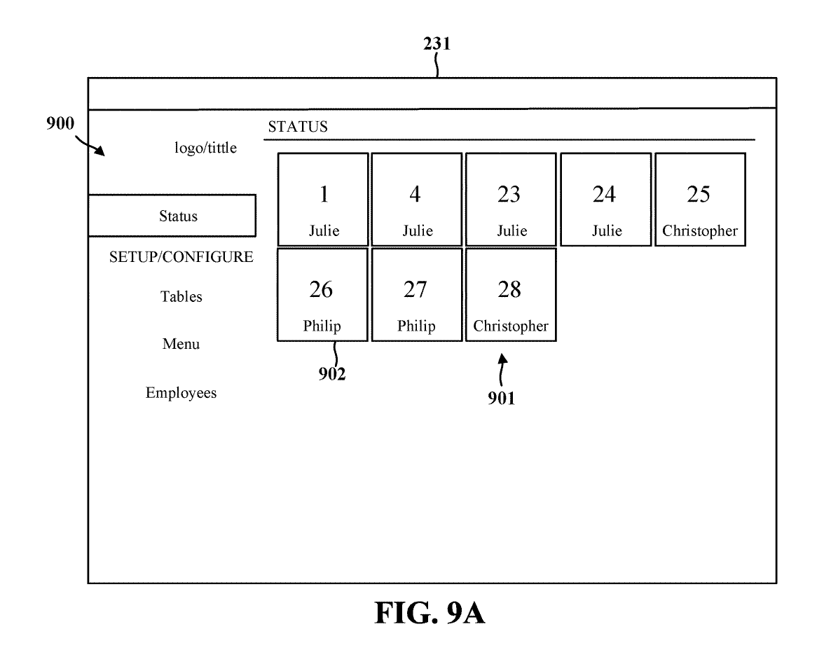

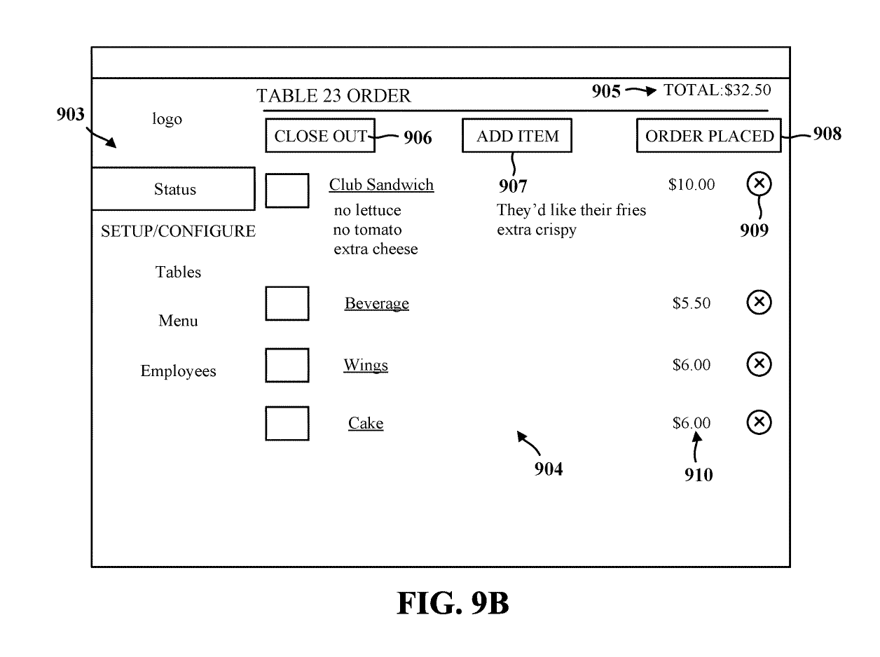

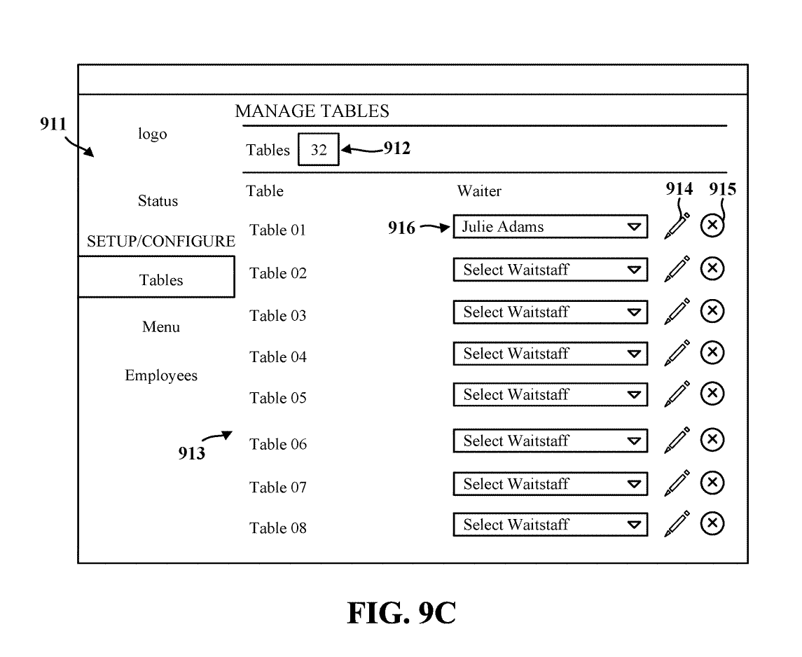

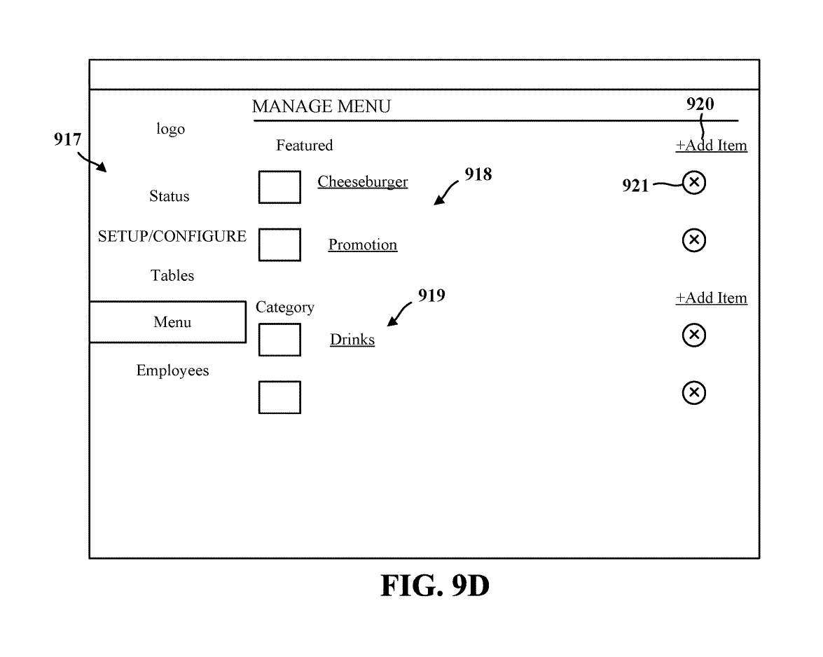

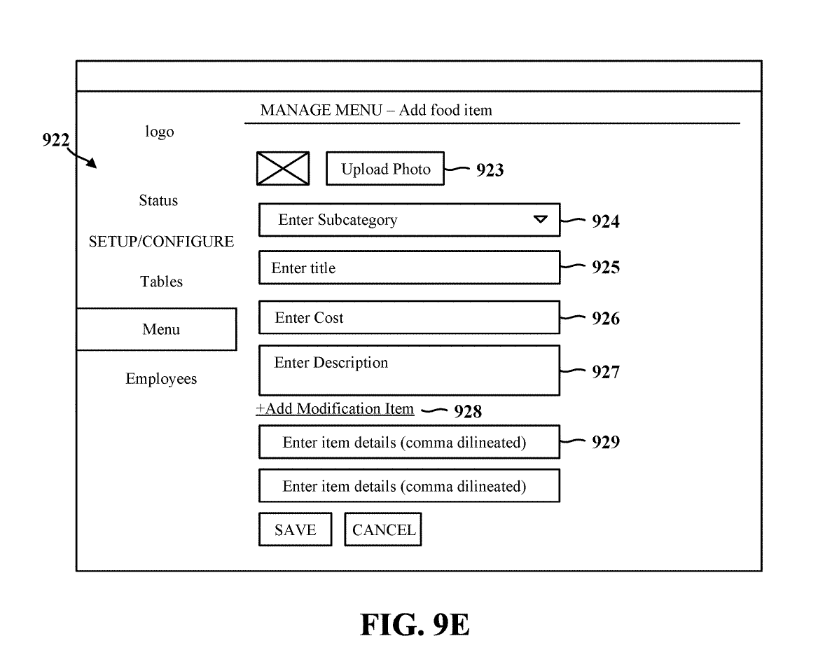

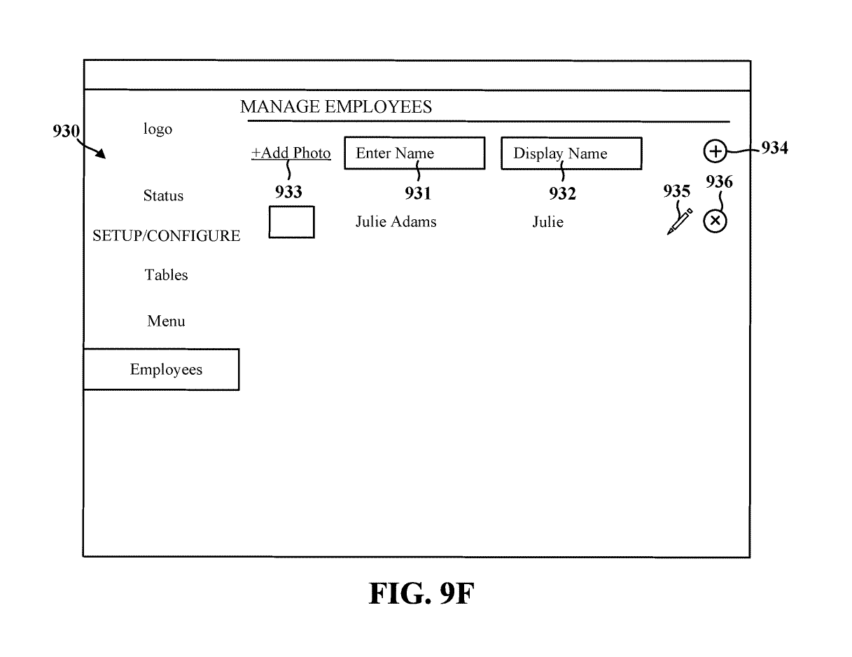

FIGS. 9A-9F illustrate examples of user interfaces on a store portal device implementing the mobile-assisted digital waiter service. For example, the store portal device may execute the Store Portal App 140 (shown in FIG. 1) to provide the user interfaces shown in FIGS. 9A-9F.

FIG. 9A illustrates a status user interface 900 displayed on a display 231 of the store portal device. The status user interface 900 provides a list of tables 901 currently occupied by customers, along with an overview of the status of each table in the restaurant. For example, each table may be represented by a box 902, which indicates the table number of the table, the wait staff person assigned to the table and may indicate whether a table requires attention. In some examples, a table requiring attention may be displayed with a particular color, such as red, while tables that do not require attention may be displayed with a different color, such as green.

Authorized restaurant personnel may view details of a particular table by tapping on the table. For example, if table 23 is tapped on, the Store Portal App may transition to a table details user interface 903, as shown in FIG. 9B. The table details user interface 903 provides a list of menu items 904 ordered by the table. The table details user interface 903 may further include, for example, a total field 905, indicating the total bill for the table, a “Close Out” button 906, which when clicked or tapped will close out the table and remove the table from the status user interface 900, an “Add Item” button 907, which allows the wait staff person to add another item to the table order, and an “Order Placed” button 908, which when clicked or tapped will clear the order from the table once the wait staff person has entered the order into the point of sale (POS) system in the restaurant. In some examples, the “Order Placed” button may be omitted if, for example, the order is automatically transmitted from the Store Portal App and/or network device to the POS system in the restaurant. In other examples, the “Order Placed” button 908 may cause the Store Portal App to generate and transmit the order to the POS system. In addition, the table details user interface 903 may further include a remove button 909, which allows a wait staff person to remove a particular menu item from the order, and a price button 910, which allows a wait staff person to edit the price of a particular menu item.

FIG. 9C illustrates a manage tables user interface 911 that enables authorized restaurant personnel to configure the number of tables and associated table numbers in the restaurant. For example, the manage tables user interface 911 may include a table amount field 912, which allows restaurant personnel to enter the number of tables in the restaurant. Once the number of tables is entered, a list of tables 913 populates below. Each table may further include an edit button 914, which allows restaurant personnel to edit the table number of the table, a remove button 915, which allows restaurant personnel to remove a table from the restaurant, and a wait staff field 916, which allows restaurant personnel to select or enter a wait staff person assigned to the table.

FIG. 9D illustrates a menu management user interface 917 that enables restaurant personnel to add, remove and/or modify menu items offered by the restaurant. The menu management user interface 917 may display both menu items 918 and menu item categories 919. For each menu item 918 and menu item category 919, the menu management user interface 917 may further include an “Add Item” button 920, which allows restaurant personnel to add a particular menu item or a menu item category, and a remove button 921, which allows restaurant personnel to remove a particular menu item or a menu item category. The menu management user interface 917 may further allow restaurant personnel to click on or tap a particular menu item 918 or menu item category 919 to edit the information for that menu item or menu item category.

For example, upon selecting (e.g., clicking on or tapping) the “Add Item” button 920 within the menu item section 918, the Store Portal App may transition to an add menu item user interface 922, as shown in FIG. 9E. The add menu item user interface 922 allows restaurant personnel to upload a photo by tapping or clicking on an “Upload Photo” button 923, enter a menu item category assigned to the menu item in a category field 924, enter a title/name of the menu item in a title field 925, enter a cost of the menu item in a cost field 926, and enter a description of the item in a description field 927. In addition, the add menu item user interface 922 may further enable restaurant personnel to enter selectable menu item modifications 928 for the menu item by transitioning to a different user interface or providing menu item modification fields 929 for the restaurant personnel to enter the menu item modifications in the add menu item user interface 922.

FIG. 9F illustrates an employee management user interface 930, which allows authorized restaurant personnel to manage employee information. For example, the employee management user interface may include an “Enter Name” field 931, which allows restaurant personnel to add the name of a new employee, a “Display Name” field 932, which allows restaurant personnel to specify the employee name to be utilized by the Store Portal App, and an “Add Photo” button 933, which allows restaurant personnel to upload a photo of the employee. After entering the employee information, restaurant personnel can click on or tap an add button 934 that adds the entered employee information into the Store Portal App. The employee management user interface 930 may further enable restaurant personnel to edit employee information by selecting an edit button 935 or remove an employee by selecting a remove button 936.

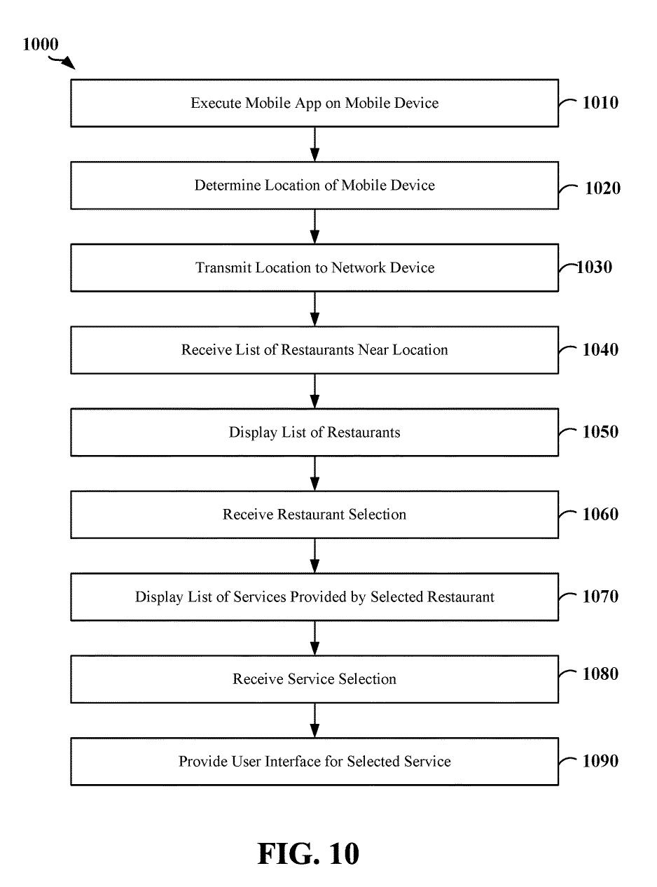

FIG. 10 is a flow chart of a method 1000 for initiating the mobile-assisted digital waiter on a mobile device. At block 1010, a mobile-assisted digital waiter application (Mobile App) is executed or launched on a mobile device of a user/customer. At block 1020, the location of the mobile device is determined, and at block 1030, the mobile device location is transmitted to a network device via a communication network. At block 1040, a list of restaurants near the mobile device's location is received from the network device, and at block 1050, the Mobile App displays the list of the restaurants on a display of the mobile device.

At block 1060, the Mobile App receives a restaurant selection selected by the user/customer via a user interface from the list of restaurants, and at block 1070, the Mobile App displays a list of services provided by the selected restaurant. At block 1080, the Mobile App receives a service selection selected by the user/customer from the list of services via a user interface, and at block 1090, the Mobile App provides a user interface for the selected service on a display of the mobile device.

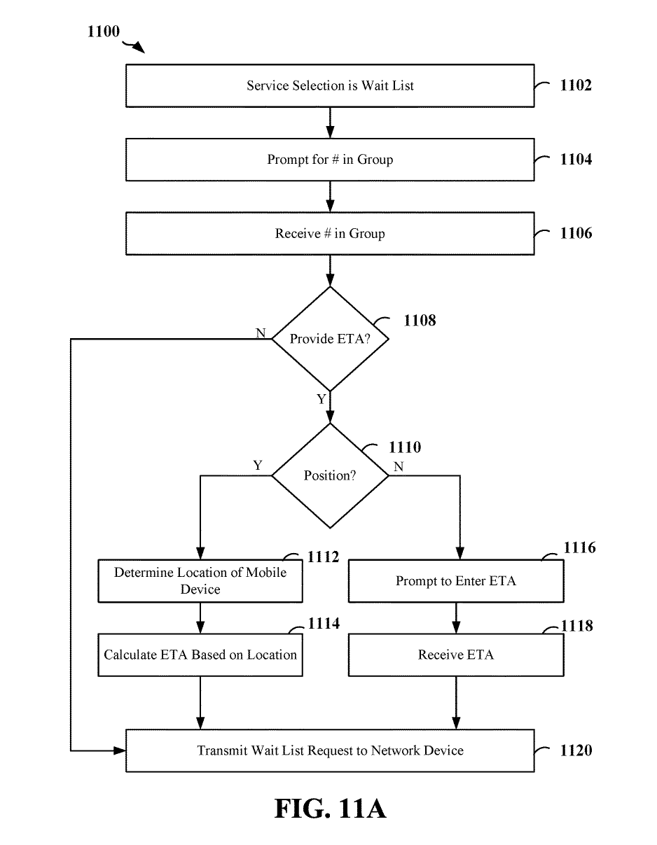

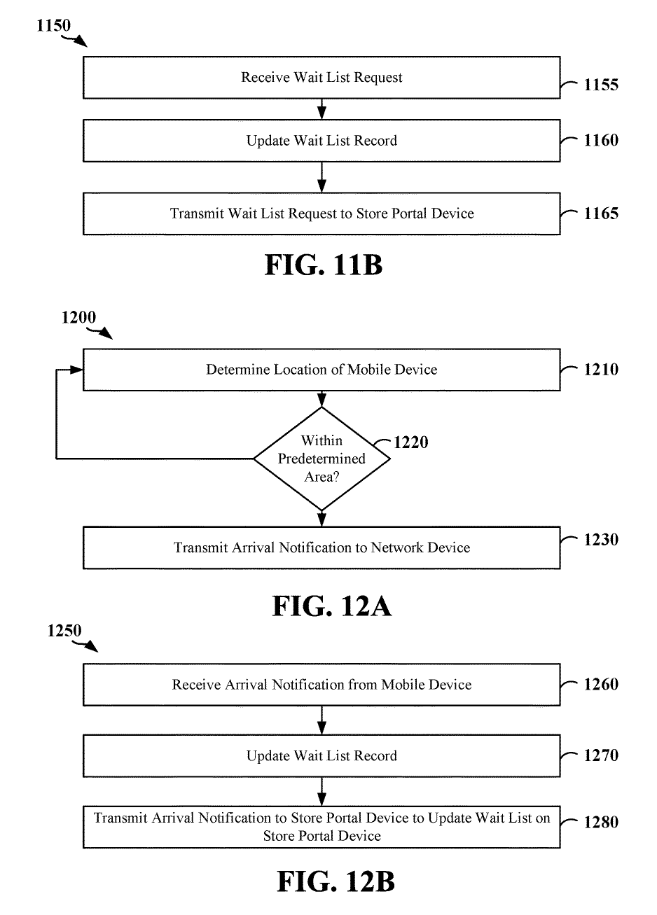

FIGS. 11A-11B are flow charts illustrating methods for facilitating a wait list request. FIG. 11A illustrates a method 1100 for providing a wait list request to a selected restaurant. The method begins at block 1102, where the Mobile App running on a mobile device of a user/customer receives a wait list request from the user/customer for a selected restaurant. For example, the user/customer may select a wait list service from a service user interface displayed on a display of the mobile device. At block 1104, the Mobile App prompts the user/customer for the number of people in the user/customer's group/party via, for example, a user interface on the mobile device. At block 1106, the Mobile App receives the number of people in the user/customer's group/party from the user/customer via the user interface.

At block 1108, the Mobile App determines whether the user/customer would like to provide an estimated time of arrival (e.g., by providing a prompt to include an estimated time of arrival with the wait list request). If the user/customer selects to provide an estimated time of arrival, at block 1110, the Mobile App determines whether the user/customer would like to enter an estimated time of arrival or calculate the estimated time of arrival based on the current location/position of the mobile device (e.g., by providing a prompt or selectable options).

If the user/customer selects to calculate the estimated time of arrival, at block 1112, the current location of the mobile device is determined (e.g., via a GPS receiver), and at block 1114, the estimated time of arrival to the selected restaurant is calculated based on the current location of the mobile device. In one example, the mobile device transmits the current location of the mobile device to a network device, which calculates the estimated time of arrival based on the current location of the mobile device, a known location of the selected restaurant, a predicted travel path between the current location of the mobile device and the selected restaurant and an average speed via a method of transportation (e.g., vehicle or walking).

If the user/customer selects to provide an estimated time of arrival, at block 1116, the Mobile App provides a prompt to the user/customer to enter the estimated time of arrival via a user interface, and at block 1118, receives the estimated time of arrival from the user/customer via the user interface. At block 1120, the wait list request, together with the number of people in the user/customer's group/party and/or the estimated time of arrival, is transmitted to the network device.

FIG. 11B illustrates a method 1150 for providing a wait list request to a restaurant. At block 1155, a network device receives a wait list request for a selected restaurant from a mobile device of a user/customer via a communication network. At block 1160, the network device updates a wait list record for the user/customer, and at block 1165, the network device transmits the wait list request to a store portal device of the selected restaurant to add the wait list request to a wait list maintained by the selected restaurant.

FIGS. 12A-12B are flow charts illustrating methods for sending an arrival notification. FIG. 12A illustrates a method 1200 for transmitting an arrival notification to a network device. At block 1210, the current location of the mobile device is determined (e.g., via a GPS receiver). At block 1220, the current location of the mobile device is compared with a predetermined distance (i.e., “fenced” distance) from the selected restaurant, and at block 1230, once the current location of the mobile device is within the predetermined distance from the selected restaurant, the Mobile App generates and transmits an arrival notification to the network device. FIG. 12B illustrates a method 1250 for transmitting an arrival notification to a store portal device of a restaurant. At block 1260, the network device receives an arrival notification from the mobile device indicating the mobile device has arrived at the selected restaurant. At block 1270, the network device updates the wait list record of the user/customer, and at block 1280, the network device transmits the arrival notification to the store portal device of the selected restaurant to update the wait list maintained by the store portal device.

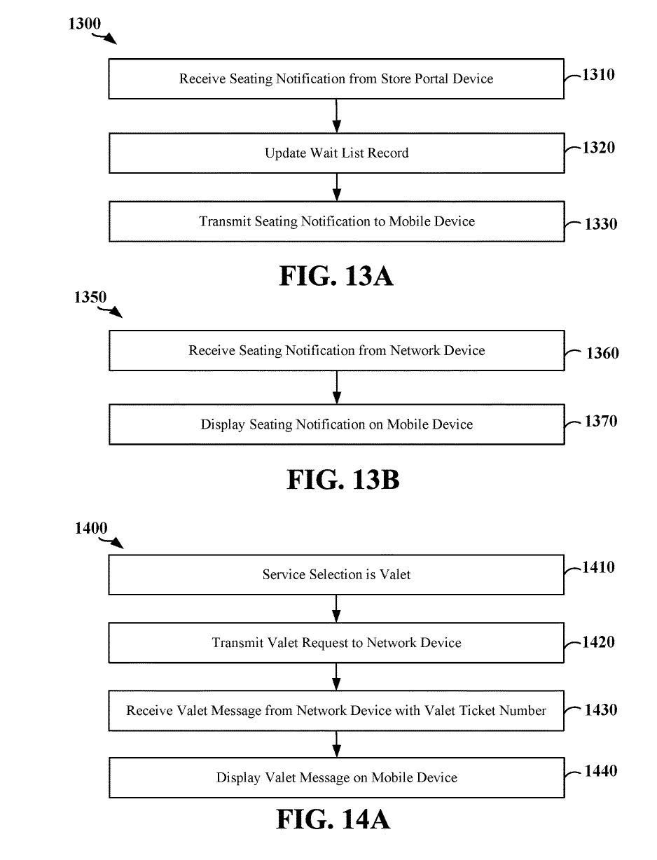

FIGS. 13A-13B are flow charts illustrating methods for sending a seating notification to a mobile device. FIG. 13A illustrates a method 1300 for receiving a seating notification from a store portal device. At block 1310, the network device receives a seating notification from a store portal device of the selected restaurant indicating that the selected restaurant has a table ready to seat the user/customer's party. At block 1320, the network device updates the wait list record of the user/customer, and at block 1330, transmits the seating notification to the mobile device. FIG. 13B illustrates a method 1350 for processing a seating notification at a mobile device. At block 1360, the mobile device receives the seating notification from the network device, and at block 1370, the mobile device displays the seating notification on the mobile device. In some examples, an audible alert is also initiated on the mobile device upon receiving the seating notification.

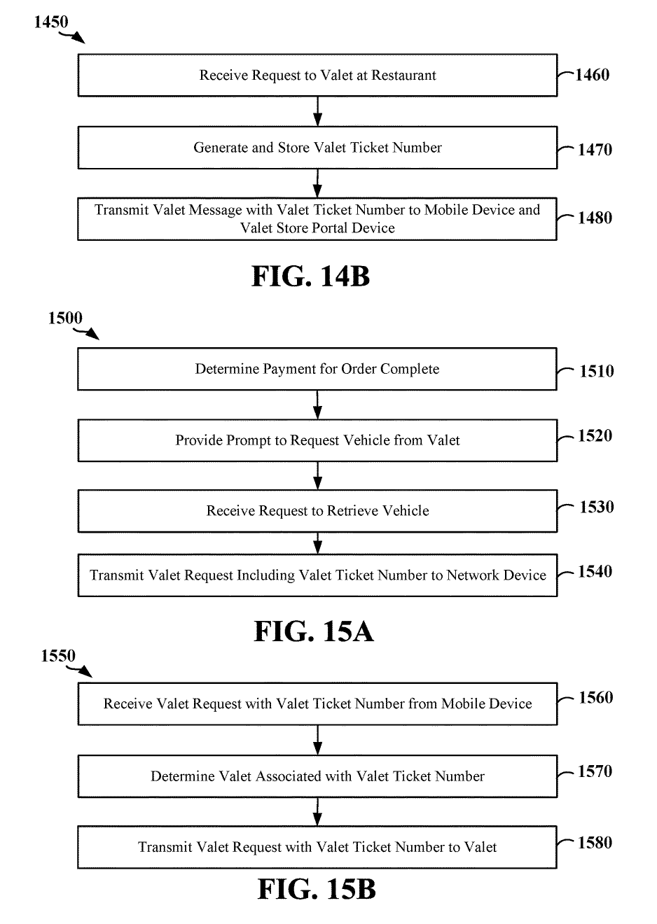

FIGS. 14A-15B are flow charts illustrating methods for providing a valet service. FIG. 14A illustrates a method 1400 for initiating a valet service on a mobile device. At block 1410, the Mobile App determines that the user/customer has selected the valet service via the user interface provided on the mobile device. In one example, the user/customer selects to receive valet service at a particular restaurant. In other examples, the user/customer selects to receive valet service at a valet stand near the current location of the mobile device. At block 1420, the Mobile App generates and transmits a valet request to the network device, requesting valet service at a particular valet stand. At block 1430, the mobile device receives a message (e.g., an SMS message) from the network device with a valet ticket number for the valet service, and at block 1440, the Mobile App displays the valet message on a display of the mobile device.

FIG. 14B illustrates a method 1450 for providing a valet ticket number to a mobile device. At block 1460, the network device receives a request from a mobile device to valet a vehicle at a particular restaurant or at a particular valet stand. At block 1470, the network device generates a valet ticket number for the vehicle and stores the valet ticket number in a customer record associated with the user/customer of the mobile device. At block 1480, the network device transmits a valet message including a valet ticket number to the mobile device. In some examples, the network device further transmits the valet ticket number to a store portal device associated with the valet stand.

FIG. 15A illustrates a method 1500 for sending a request for valet service to retrieve a vehicle from a valet stand. At block 1510, the Mobile App on the mobile device of the user/customer determines that payment for an order at a restaurant is complete. At block 1520, the Mobile App provides a prompt to the user/customer on a user interface of the mobile device to request the user/customer's vehicle from the valet. At block 1530, the Mobile App receives a request to retrieve the vehicle (e.g., by the user/customer selecting to retrieve the vehicle via the user interface), and at block 1540, the Mobile App generates and transmits a valet vehicle retrieval request including the valet ticket number to the network device.

FIG. 15B illustrates a method 1550 for providing a valet vehicle retrieval request to a valet stand. At block 1560, the network device receives a valet vehicle retrieval request including a valet ticket number from a mobile device. At block 1570, the network device determines the valet stand associated with the valet ticket number. In one example, the network device may access a customer record associated with the user/customer of the mobile device to determine the valet stand at which the user/customer's vehicle is valeted. In other example, the network device may access a table including valet ticket numbers and associated valet stand identifiers to determine the valet stand at which the user/customer's vehicle is valeted. At block 1580, the network device transmits the valet vehicle retrieval request with the valet ticket number to a store portal device of the valet stand/attendant.

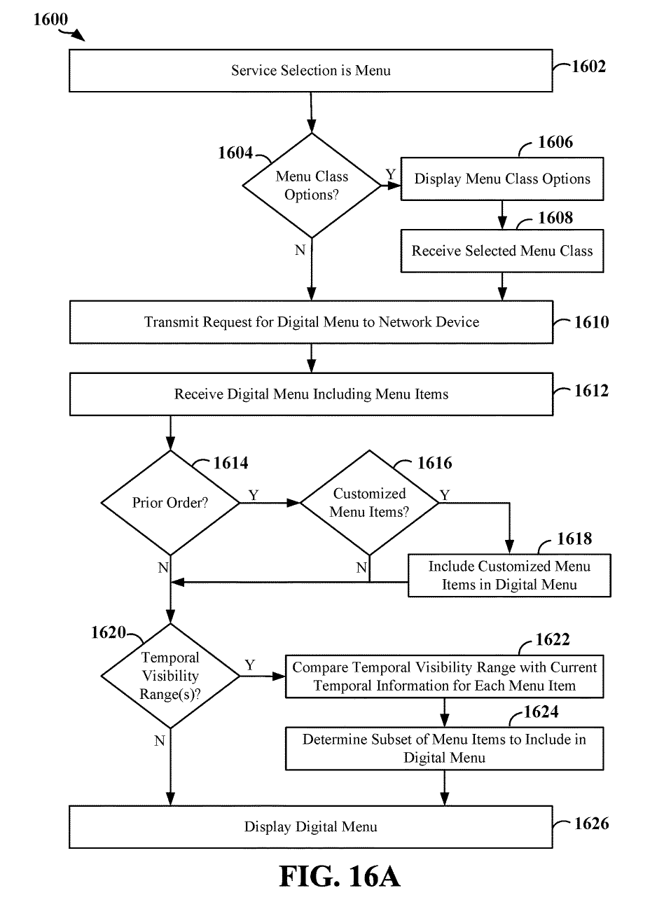

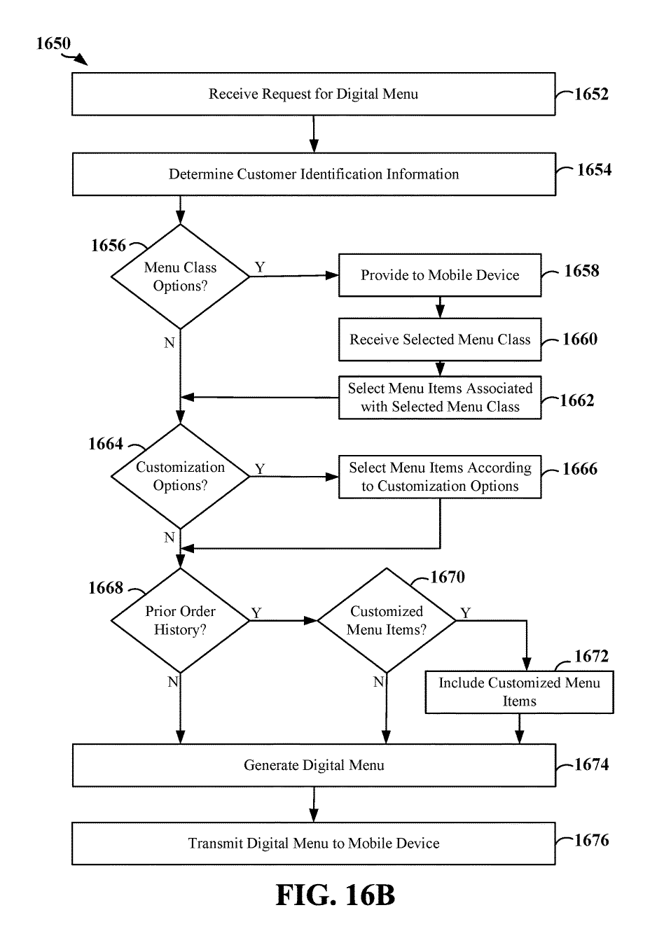

FIGS. 16A-16B are flow charts illustrating methods for providing a digital menu to a mobile device. FIG. 16A illustrates a method 1600 for rendering a digital menu of a restaurant on a display of a mobile device. At block 1602, the Mobile App determines that the user/customer has selected to receive/view a digital menu of a selected restaurant. At block 1604, the Mobile App further determines whether the restaurant provides menu class options (e.g., dine-in, take-out, delivery, child, etc.). For example, the Mobile App may query the network device to retrieve a list of menu class options. If menu class options for the restaurant exist, at block 1606, the Mobile App displays the menu class options on the display of the mobile device. Then, at block 1608, the Mobile App receives a selected menu class from the user/customer via the user interface.

At block 1610, the Mobile App generates and transmits a request for a digital menu, including the selected menu class, to the network device. At block 1612, the Mobile App receives the digital menu including a plurality of menu items associated with the selected menu class from the network device. At block 1614, the Mobile App determines whether the user/customer has placed a prior order with the restaurant, and if so, at block 1616, determines whether the user/customer ordered one or more customized menu items from the restaurant. If so, at block 1618, the Mobile App includes the customized menu items in the digital menu. At block 1620, the Mobile App further determines whether one or more of the menu items has a temporal visibility range (e.g., date, day(s) of week, time(s) of day, season, etc.) associated with it. If so, at block 1622, the Mobile App compares the temporal visibility range with current temporal information (e.g., current day, date, time, and season) for each menu item containing a temporal visibility range, and at block 1624, determines a subset of menu items having the current temporal information in the temporal visibility range to include in the digital menu. At block 1626, the digital menu is displayed to the user/customer on the display of the mobile device.

FIG. 16B illustrates a method 1650 for generating a digital menu for a restaurant. At block 1652, the network device receives a request for a digital menu of a selected restaurant from the mobile device. At block 1654, the network device further determines customer identification information associated with a user/customer of the mobile device. At block 1656, the network device determines whether menu class options are available for the restaurant. If so, at block 1658, the network device provides the menu class options to the mobile device, and at block 1660, receives a selected menu class from the mobile device. Then, at block 1662, the network device selects the menu items associated with the selected menu class.

At block 1664, the network device further determines whether any customization options (e.g., temporal restrictions and/or temporal features) are available for the restaurant. If so, at block 1666, the network device selects and modifies the menu items according to the customization options. In addition, at block 1668, the network device determines whether the user/customer has a prior order history associated with the restaurant using, for example, the customer identification information. If so, at block 1670, the network device determines whether the user/customer previously ordered any customized menu items from the restaurant, and if so, at block 1672, includes the customized menu items in the digital menu. At block 1674, the network device generates the digital menu, and at block 1676, the network device transmits the digital menu to the mobile device.

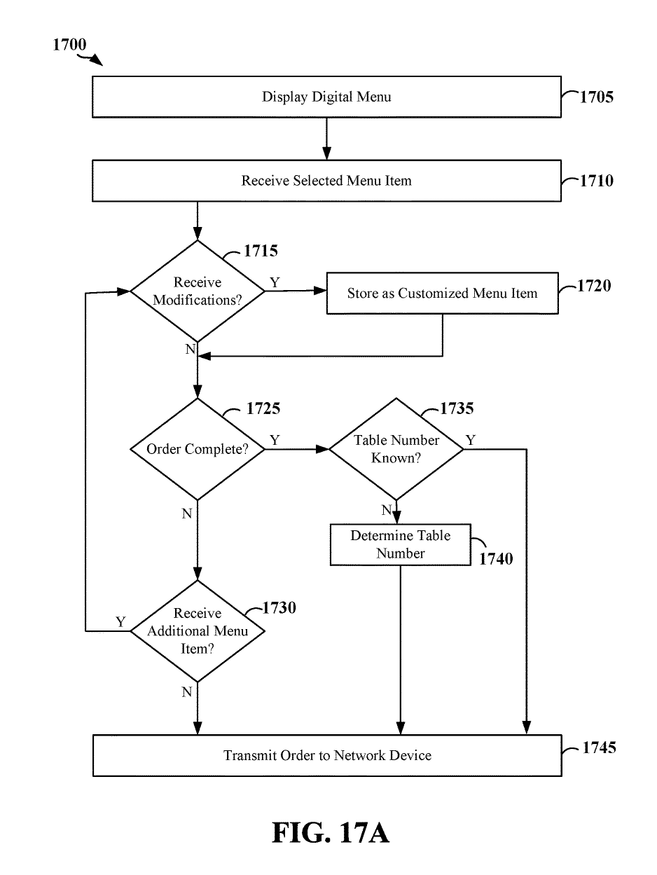

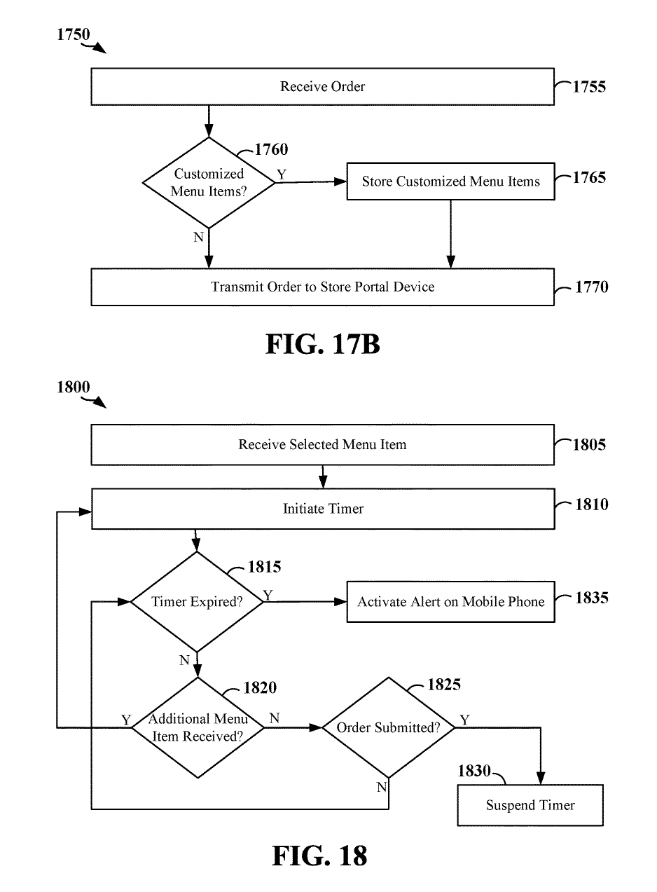

FIGS. 17A and 17B are flow charts illustrating methods for providing an order to a store portal device. FIG. 17A illustrates a method 1700 for providing an order to a network device. At block 1705, the Mobile App displays the received digital menu for a restaurant, as described above in connection with FIG. 16A. At block 1710, the Mobile App receives a selected menu item from the user/customer via the user interface. At block 1715, the Mobile App determines whether the user/customer entered/selected any menu item modifications for the selected menu item, and if so, at block 1720, the Mobile App may store the customized menu item for future orders with the restaurant.

At block 1725, the Mobile App determines whether the order is complete. For example, the user/customer may select a “Submit Order” button on the user interface of the mobile device to indicate that the order is complete. If the order is not complete, at block 1730, the Mobile App determines whether additional selected menu items have been received, and if so, returns to block 1715 to determine whether any menu item modifications for those selected menu items were received. Once the order is complete, at block 1735, the Mobile App determines whether the table number of the table at which the user/customer is seated is known (if applicable), and if not, at block 1740, the Mobile App determines the table number (e.g., by retrieving the table number from a beacon on/under the table). Thereafter, at block 1745, the Mobile App submits the order including the selected menu item(s) to the network device.

FIG. 17B illustrates a method 1750 for providing an order to a selected restaurant. At block 1755, the network device receives an order from a mobile device of a user/customer. At block 1760, the network device determines whether any of the selected menu items in the order are customized menu items, and if so, at block 1765, stores the customized menu items in for future use. Then, at block 1770, the network device transmits the order to a store portal device of the restaurant.

FIG. 18 is a flow chart illustrating a method 1800 for activating an alert on a mobile device to submit an order. At block 1805, the Mobile App receives a selected menu item from a user/customer associated with the mobile device. At block 1810, upon receiving the selected menu item, the Mobile App initiates a timer on the mobile device. At block 1815, the Mobile App determines whether the timer has expired, and if not, at block 1820, determines whether an additional selected menu item has been received. If so, the Mobile App returns to block 1810 to re-start or re-initiate the timer. If the timer has not expired and an additional menu item has not been received, at block 1825, the Mobile App determines whether the user/customer has requested to submit the order (e.g., by selecting a “Submit Order” button on the user interface). If so, the Mobile App suspends the timer at block 1830. However, if the timer expires before receiving an additional selected menu item or receiving a request to submit the order, at block 1835, the Mobile App activates an alert (audible and/or visual) on the mobile device.

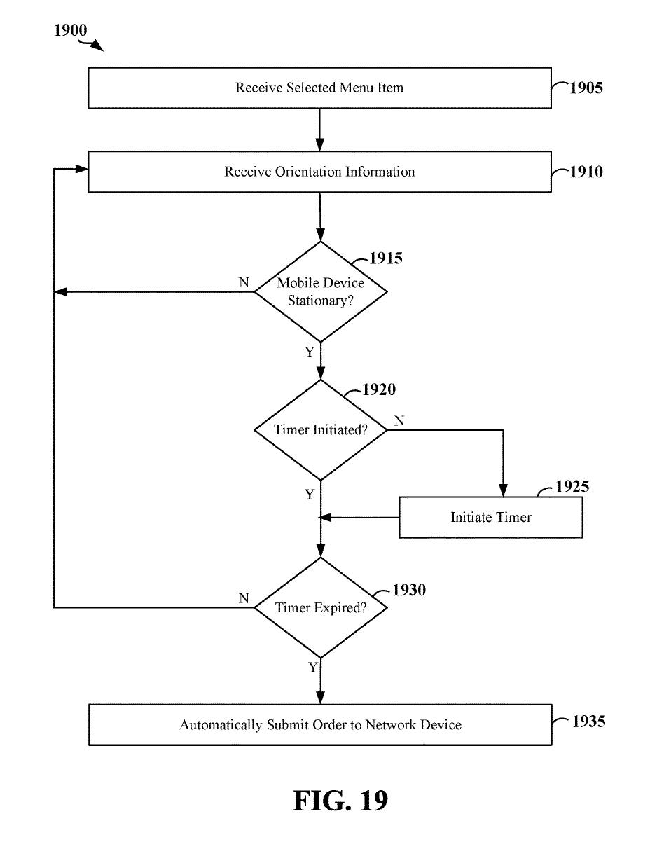

FIG. 19 is a flow chart illustrating a method 1900 for automatically submitting an order on a mobile device. At block 1905, the Mobile App receives a selected menu item from a user/customer of the mobile device. At block 1910, the Mobile App receives orientation information from the mobile device, and at block 1915, determines whether the orientation information indicates that the mobile device is stationary (i.e., set down on a table top). If so, at block 1920, the Mobile App determines whether a timer has been initiated on the Mobile App as a result of the stationary orientation of the mobile device, and if not, at block 1925, initiates a timer on the mobile device. At block 1930, the Mobile App determines whether the timer has expired, and if not, obtains new orientation information for the mobile device. If the timer expires prior to receiving orientation information indicating the mobile device is in use (i.e., not stationary), the Mobile App automatically submits the order including the selected menu item(s) to the network device.

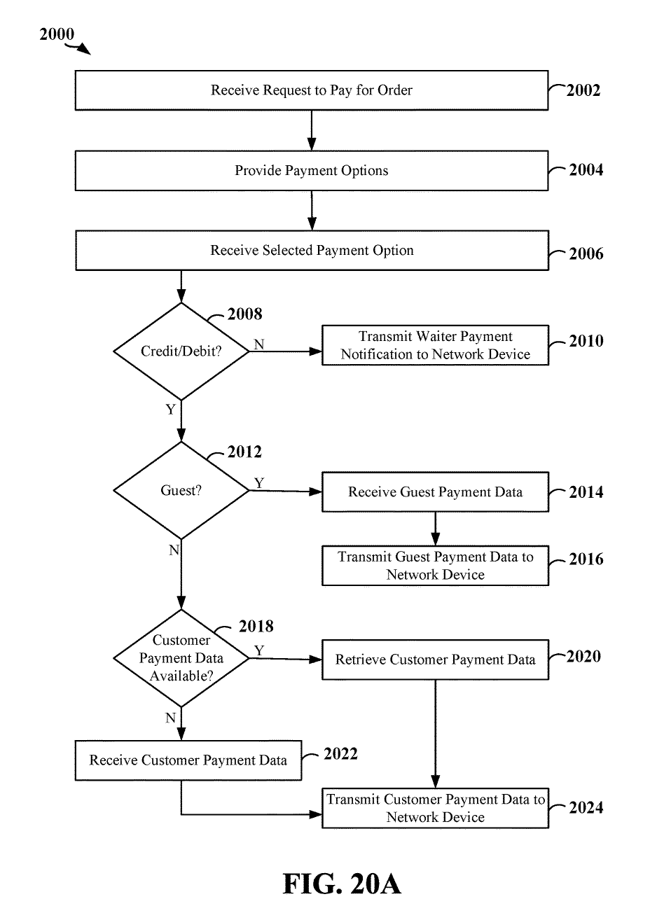

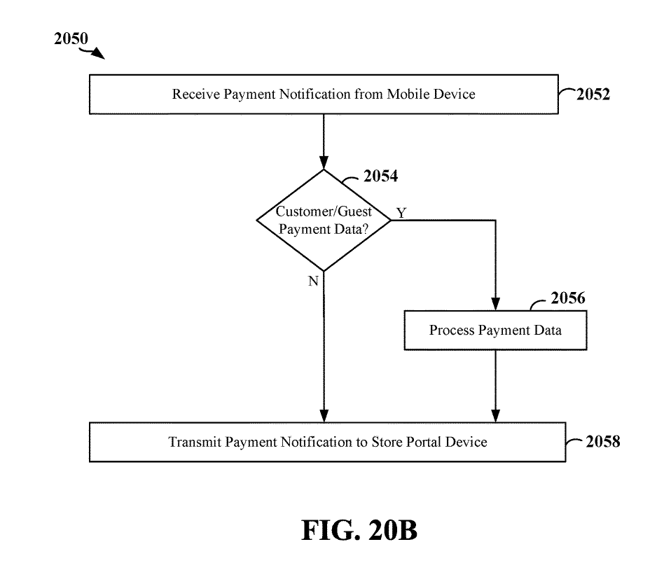

FIGS. 20A and 20B are flow charts illustrating methods for providing payment. FIG. 20A illustrates a method 2000 for submitting payment on a mobile device. At block 2002, the Mobile App receives a request to pay for an order from the user/customer of the mobile device via the user interface. At block 2004, the Mobile App provides payment options (e.g., Cash, Credit/Debit, etc.) to the user/customer via the user interface, and at block 2006, receives a selected payment option from the user/customer via the user interface.

At block 2008, the Mobile App determines whether the selected payment option is a Credit/Debit card payment option. If not, at block 2010, the Mobile App transmits a waiter payment notification to the network device indicating that the user/customer will be making payment via cash and/or directly with the wait staff person of the restaurant. If the selected payment option is a Credit/Debit payment option, at block 2012, the Mobile App determines whether the user/customer will be making payment using a Guest Credit/Debit card. If so, at block 2014, the Mobile App receives guest payment data (e.g., credit/debit card information of the guest), and at block 2016, securely transmits the guest payment data to the network device.

If the user/customer indicates that payment is being made using a Credit/Debit card of the user/guest, at block 2018, the Mobile App determines whether customer payment data is available (e.g., pre-stored in secure storage on the mobile device). If so, the Mobile App retrieves the customer payment data from the secure storage. If not, at block 2022, the Mobile App receives the customer payment data from the user/customer via the user interface. Then, at block 2024, the Mobile App transmits the customer payment data to the network device.

FIG. 20B illustrates a method 2050 to facilitate payment via a network device. At block 2052, the network device receives a payment notification from a mobile device. At block 2054, the network device determines whether the payment notification includes customer or guest payment data (e.g., credit/debit card information). If so, at block 2056, the network device processes the customer/guest payment data via, for example, a credit card processing system. At block 2058, the network device transmits the payment notification to the store portal device at the restaurant. If the network device successfully processed the credit/debit card information of the customer or a guest, the payment notification transmitted to the store portal device will indicate that payment has been processed. Otherwise, the payment notification will include an indication that the user/customer will be making payment via cash and/or directly with the wait staff person of the restaurant.

As those skilled in the art will readily appreciate, various aspects described throughout this disclosure may be extended to any suitable telecommunication system, network architecture, and communication standard. By way of example, various aspects may be applied to wireless communication systems, such as those employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable wireless communication systems. Various aspects may also be applied to communication systems employing Asynchronous Transfer Mode (ATM), Ethernet, Internet Protocol and/or other local area network or wide area network standards. The actual telecommunication system, network architecture, and/or communication standard employed will depend on the specific application and the overall design constraints imposed on the system.

One or more of the components and functions illustrated in FIGS. 1, 2, and/or 3 may be rearranged and/or combined into a single component or embodied in several components without departing from the invention. Additional elements or components may also be added without departing from the invention. The apparatus, devices, and/or components illustrated in FIGS. 1, 2, and/or 3 may be configured to perform the methods, features, or steps illustrated in FIGS. 4 and/or 6. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A mobile device in communication with a communication network, comprising:
a display;
a user input device;
a wireless transceiver configured to receive data corresponding to a digital menu associated with a restaurant via the communication network; and
a processor configured to:
render the data corresponding to the digital menu on the display, the digital menu including a plurality of menu items, the plurality of menu items including at least one customized menu item corresponding to a prior order placed with the restaurant by a user of the mobile device;
determine a selected menu item of the plurality of menu items selected by the user of the mobile device via the user input device; and
transmit the selected menu item to a network device associated with the restaurant via the wireless transceiver and the communication network to place a current order with the restaurant.

2. The mobile device of claim 1, wherein the digital menu is customized based on at least one of a date, a day of the week, a time of day, or a menu class selected by the user of the mobile device.

3. The mobile device of claim 2, wherein the processor is further configured to:
render additional data corresponding to menu class options on the display;
determine the menu class selected from the menu class options by the user of the mobile device via the user input device; and
transmit the menu class to the network device via the wireless transceiver and the communication network;
wherein the digital menu corresponds to the menu class selected by the user of the mobile device.

4. The mobile device of claim 1, wherein the processor is further configured to:
determine a respective temporal visibility range for each of the plurality of menu items on the digital menu;
compare the temporal visibility range for each of the plurality of menu items with current temporal information to determine a subset of menu items having the current temporal information in the respective temporal visibility range; and
render the subset of menu items on the display.

5. The mobile device of claim 1, wherein the selected menu item includes at least one menu item modification entered by the user via the user input device.

6. The mobile device of claim 1, wherein the processor is further configured to:
render the current order including the selected menu item on the display; and
receive a submit order command from the user of the mobile device via the user input device;
wherein the processor transmits the current order including the selected menu item to the network device in response to receiving the submit order command.

7. The mobile device of claim 6, wherein the processor is further configured to:
initiate a timer on the mobile device in response to determining the selected menu item; and
activate an alert on the mobile device upon expiration of the timer when the submit order command has not been received.

8. The mobile device of claim 6, further comprising:
an orientation system configured to monitor motion of the mobile device;
wherein the processor is further configured to:
receive orientation information from the orientation system;
determine that the mobile device is stationary based on the orientation information;
initiate a timer on the mobile device in response to determining that the mobile device is stationary; and
automatically transmit the current order including the selected menu item to the network device upon expiration of the timer.

9. The mobile device of claim 1, wherein the processor is further configured to:
determine a table number corresponding to a location of the mobile device; and
transmit the table number with the selected menu item to the network device.

10. The mobile device of claim 1, wherein the processor is further configured to:
transmit a wait list request to the network device requesting the user be placed on a wait list at the restaurant.

11. The mobile device of claim 10, further comprising:
a positioning system configured to calculate a current location of the mobile device;
wherein the processor is further configured to:
transmit an arrival notification to the network device when the current location of the mobile device is within a predetermined distance from the restaurant.

12. The mobile device of claim 10, wherein the processor is further configured to:
receive a seating notification from the network device indicating that the restaurant has a table ready to seat the user; and
render the seating notification on the display.

13. The mobile device of claim 1, wherein the processor is further configured to:
receive a valet message from the network device that includes a valet ticket number to valet a vehicle associated with the customer; and
render the valet message on the display.

14. The mobile device of claim 13, wherein the processor is further configured to:
determine payment for the current order has been completed;
provide a prompt on the display for the user to request their vehicle using the valet ticket number; and
transmit a valet request including the valet ticket number to the network device to request the vehicle.

15. The mobile device of claim 1, wherein the processor is further configured to:
determine the at least one customized menu item based on the prior order stored in the mobile device; and
include the customized menu item in the digital menu.

16. A method for implementing a mobile-assisted digital waiter, comprising:
receiving, via a network interface coupled to a communication network, a request for a digital menu of a restaurant from a customer operating a mobile device in wireless communication with the communication network;
determining, by a processor, a customer identifier of the customer;
retrieving, from a memory, a prior order history of the customer based on the customer identifier;
generating, by the processor, the digital menu based on the prior order history, the digital menu including a plurality of menu items, the plurality of menu items including at least one customized menu item selected from the prior order history; and
transmitting, via the network interface, the digital menu to the mobile device.

17. The method of claim 16, further comprising:
receiving, via the network interface, a current order from the mobile device, the current order including a selected menu item selected from the plurality of menu items by the customer; and
providing, via the network interface, the current order to a store portal device of the restaurant.

18. The method of claim 16, further comprising:
receiving, via the network interface, an additional request for an additional digital menu of an additional restaurant from an additional customer.

19. The method of claim 16, wherein the digital menu is customized based on at least one of a date, a day of the week, a time of day, or a menu class selected by the user of the mobile device.

20. The method claim 19, wherein generating the digital menu further comprises:
transmitting, via the network interface, a plurality menu class options to the mobile device;
receiving, from the mobile device, via the network interface, a menu class selected from the menu class options by the customer; and
generating the digital menu corresponding to the menu class selected by the customer.
